(19) United States
(12) Patent Application Publication
(10) Pub. No.: US 2023/0241715 A1
(43) Pub. Date: Aug. 3, 2023

(54) SYSTEM AND METHOD OF DETECTING OR PREDICTING MATERIALS IN MICROELECTRONIC DEVICES AND LASER-BASED MACHINING TECHNIQUES WITH CO2 ASSISTED PROCESSING

(71) Applicants: Nicholas May, Mansfield Center, CT (US); Hongbin Choi, Willimantic, CT (US); Valery Ray, Farmington, CT (US); Pouya Tavousi, Somerville, MA (US); Sina Shahbazmohamadi, Stamford, CT (US); Adrian Phoulady, Willmantic, CT (US)

(72) Inventors: Nicholas May, Mansfield Center, CT (US); Hongbin Choi, Willimantic, CT (US); Valery Ray, Farmington, CT (US); Pouya Tavousi, Somerville, MA (US); Sina Shahbazmohamadi, Stamford, CT (US); Adrian Phoulady, Willmantic, CT (US)

(21) Appl. No.: 18/160,986

(22) Filed: Jan. 27, 2023

Related U.S. Application Data
(60) Provisional application No. 63/304,248, filed on Jan. 28, 2022.
(60) Provisional application No. 63/304,311, filed on Jan. 28, 2022.

(51) Int. Cl. B23K 26/14; G06T 7/00; B23K 26/00; B23K 26/035

(52) U.S. Cl. CPC B23K 26/1438; G06T 7/0004; B23K 26/0006; B23K 26/035; G06T 2207/30164; G06T 2207/20081

(57) ABSTRACT

Systems and methods for detecting a material composition of a specimen and for cross-sectioning of the specimen. The system includes an imaging system, a femtosecond laser source, and optionally, a synchronized CO₂ injection system. The imaging system is configured to capture image data of a surface of the specimen that has been etched by the laser. A machine learning model is applied to determine a predicted material composition of the specimen based at least in part on the image data. The machine learning model is trained to receive as input the image data and/or one or more quantified surface texture parameters determined from the image data and to produce as output an indication of a predicted material composition. A laser-based milling system is configured to use these material composition detection mechanisms to automatically determine when the laser system has milled through a first layer of a specimen and reached a second layer, and to adjust the operation of the milling system in response. The CO2 injection system can be used to provide fast, clean, high aspect ratio cross-sectioning of microelectronic parts for providing high-precision and high-throughput machining for material removal (e.g., for intrusive inspection of electronic components).

### CROSS-REFERENCE TO RELATED APPLICATIONS

This application claims priority to U.S. Provisional Patent Application No. 63/304,248, filed Jan. 28, 2022, and U.S. Provisional Patent Application No. 63/304,311, filed Jan. 28, 2022, the entire contents both of which are hereby incorporated by reference in their entirety.

### FIELD OF THE INVENTION

The present disclosure relates to systems and methods for determining or predicting a type of material used in small-scale samples including, for example, microelectronic devices, and to systems and methods for laser machining of microelectronics with a CO₂ gas delivery system for targeted access to internal structures. The present disclosure also relates to techniques for laser-based machining accompanied by the application of CO₂ to the surface being machined where the system is configured to synchronizing the movement of the CO₂ spot on the surface of the sample with the movement of the laser spot projected on the surface of the sample.

### BACKGROUND OF THE INVENTION

With the ever-growing miniaturization of features in microelectronic parts, the use of destructive methods are increasingly relied-upon for inspection, failure analysis, and reverse engineering of microelectronics. Studying the buried structure of microelectronic parts with high-resolution imaging, requires material to be removed in a precise fashion to expose the region of interest. Based on the machining requirements and the composition of the material being ablated, lasering and scanning parameters must be fine-tuned in order to achieve satisfactory results. However, accurate information about the material composition of a sample of interest is often not available, and the material composition of the sample must therefore be inferred. Furthermore, endpointing of a deprocessing system becomes increasingly difficult due to the large material removal rate of laser systems.

Conventional methods for material detection, such as focused ion beam (FIB) milling, mechanical etching, and chemical etching, include a trade-off between accuracy of the material detection and throughput of the detection process. Ultrashort pulsed (USP) laser which offers a thermal material ablation, can drastically improve such trade-off, by providing fast yet precise machining. However, due to a lack of a mechanistic understanding of the laser and matter interaction, the laser machining practices are often trial-and-error, with no systematic method for generating proper machining recipes.

In some instances, non-trial-and-error-based methods that could be used for material detection include energy dispersive spectroscopy (EDS) and laser induced breakdown spectroscopy (LIBS). The complexities associated with integrating such techniques with laser machining may be a prohibitive factor on the way of using them.

Non-destructive methods such as X-ray tomography and Tera Hertz Imaging may be utilized. However, these approaches are limited in resolution of 700 nm to 1 micron. Other techniques that provide for a more thorough analysis may utilize, for example, scanning electron microscopes (SEMs), Focused Ion beams (FIBs) and Transmission Electron Microscope (TEMs). Such analyses in turn require sample preparation which entails targeted access to the areas of interest and buried layers. The stacked structure of ICs can make it difficult to access such internal attributes.

The “deprocessing” of ICs (i.e., to obtain targeted access to the internal structure of the IC) may utilize a combination of methods such as wet etching, plasma (dry) etching, grinding, and polishing. However, an advanced laboratory having one of more of the following pieces of mechanical equipment is required: a semi-automated polishing machine, a semi-automated milling machine, a laser, a gel etch, a computer numerical control (CNC) milling machine, and an ion beam milling machine. Additionally, modern IC “chips” consist of several metal layers, passivation layers, vias, contact, poly, and active layers. A reverse engineer/failure analyst would be required to determine the etchants and tolls as well as the time needed to remove each layer. Parameters may vary from layer-to-layer and from material-to-material.

When deprocessing an IC, the layer surface has to be maintained as planar, and each individual layer should be etched carefully and accurately. The planarity of the layer could be conformal or planarized. In a planarized layer, only one layer appears at a time. Conformal layers, in which some portion of the different layers and vias could appear on the same plane can make deprocessing even more complex and challenging. One must be careful to remove one material but not another (e.g., removing a metal layer without affecting the vias) during deprocessing.

In situ solutions such as focused ion beam (FIB) using conventional liquid metal ion sources may be relatively easy to use, but the milling rates are much too low for the amounts of material that need to be removed for some applications. Noble gas plasma ion source FIBs can achieve up to 20 times faster milling and can cross-section individual interconnects in much less time. However, they are still not fast enough at simultaneously cross-sectioning multiple large interconnect structures, stacked dies, or fully packaged devices. Furthermore, insulating samples suffer from poor milling due to charge accumulation. Because of these (and other) challenges, deprocessing can involve a trial-and-error process which consequently demands many samples to reach the optimized process.

Accordingly, systems and methods of detecting or predicting materials used in microelectronic devices that balance accuracy with throughput are desired. Additionally, systems and methods of conducting failure/reliability analyses of microelectronic internal structures that balance accuracy with throughput are desired.

### SUMMARY OF THE INVENTION

Thus, in various implementations, the systems and methods described in the examples herein provide a technique that detects material composition based on surface texture parameters derived from confocal images of a lasered area. A multilayer fully connected neural network is trained to predict the material composition of the sample with a single image of the surface. Furthermore, although lasering may start before material composition can be detected, similar to LIBS, the amount of lasering that is needed for this purpose is minimal, for example, only using a single pass of the laser. A multilayer fully connected neural network was trained in order to predict the material composition of samples.

In some implementations, the invention provides a material detection method using femtosecond laser, confocal imaging and image processing. In some implementations, the material detection method is incorporated into a laser milling system to provide a feedback mechanism for automated end-pointing in fast inspection of microelectronics. In some implementations, the system includes an AI model that is trained to detect material composition based on surface texture parameters derived from confocal images using reflected light from the laser milled area.

In some implementations, the methods and systems described herein are configured to predict material composition during a laser machining process by utilizing surface texture extracted from confocal images of a lasered sample. After training an AI model, a 50× magnification confocal image with a field of view of 250 by 250 microns provides sufficient data in order detect the material being lasered. Furthermore, although lasering must start before material composition can be detected, the amount of lasering that is needed for this purpose is minimal only requiring a single pass of the laser. In some implementations, the AI model includes a multilayer fully connected neural network trained to receive as input one or more quantified parameters extracted from the captured image data and to produce as output a prediction of the material composition of sample(s).

In some implementations, the invention provides a technique for prediction of sample material composition using a combination of femtosecond pulse laser and confocal imaging. A neural network is trained by the surface metrics extracted from confocal images of lasered samples. The trained neural network is then able to predict the material composition, when the laser machining parameters and the confocal images were provided as input to the trained neural network. In some implementations, the method provides a fast and reliable, yet affordable solution for material characterization that is much needed for proper machining of microelectronic parts for conducting inspection, failure analysis and reverse engineering. Further, by integrating the proposed method into an automated system that will use the image processing data as a feedback to control the laser system, in real time, it can serve as an end-pointing and parameter tuning mechanism that that offers new capabilities in terms of sample preparation applications.

In one embodiment, the invention provides a material detection system including a laser system, an imaging system, and an electronic controller. The laser system is configured to controllably etch a specimen and the imaging system is configured to capture image data of the etched surface of the specimen. The electronic controller is configured to receive image data from the imaging system and to apply a machine learning model to determine a material composition of the specimen based at least in part on the image data. The machine learning model is trained to receive as input the image data and/or one or more quantified surface texture parameters determined from the image data and to produce as output an indication of a predicted material composition.

In another embodiment, the invention provides a method of training a machine learning model for a material detection system. The material detection system is operated to controllably etch a plurality of different samples and to capture image data of each etched sample. The plurality of different samples includes specimens of different material compositions. A set of training data is generated for each sample of the plurality of different samples and each set of training data includes an indication of a material composition of the sample and one or more texture parameters for the sample based on the captured image data. The machine learning model is then trained using the sets of training data. The machine learning model is trained to produce as output an indication of a predicted material composition in response to receiving an input including one or more texture parameters for a sample of unknown material composition.

In yet another embodiment, the invention provides a laser-based milling system configured to mill a specimen including a plurality of layers, wherein adjacent layers of the specimen are formed of different material compositions. The laser-based milling system includes a femtosecond laser system, an imaging system, and an electronic controller. The femtosecond laser system is configured to controllably etch the specimen and the imaging system is configured to capture image data of the etched surface of the specimen. The electronic controller receives the image data and applies a machine learning model to determine a material composition of the specimen based at least in part on the image data. The electronic controller then continues etching the specimen in response to determining, based on the output of the machine learning model, that the etched surface of the specimen is of a first material composition and stops the etching of the specimen in response to determining, based on the output of the machine learning model that the etched surface of the specimen is of a second material composition. Because a first layer of the specimen is formed of the first material composition and the second layer is formed of the second material composition, determining that the etched surface of the specimen is of the second material composition indicates that the laser system has etched through the first layer and has exposed a second layer of the specimen.

In some implementations, the systems and methods described herein provide an intelligent system that combines a femtosecond pulsed laser with a synchronized CO₂ injection system that enables fast, clean, high aspect ratio cross-sectioning of microelectronic parts. In some implementations, the system is configured to mill a high aspect ratio trench to expose the buried structures within a microelectronic device (e.g., a CPU IC). Such a trench would not be feasible to mill using traditional FIB methods due to its depth.

In one embodiment, the invention provides a laser-based machining system including a femtosecond laser source, a laser scanning system, a CO₂ nozzle, a CO₂ nozzle movement stage, and an electronic controller. The laser scanning system is configured to direct a laser beam from the laser source to a surface of a sample and to controllably adjust a location of a laser spot where the laser beam contacts the surface of the sample. The CO₂ nozzle is configured to emit a CO₂ jet and the CO₂ nozzle movement stage is configured to controllably adjust a location of a CO₂ spot where the CO₂ jet contacts the surface of the sample by adjusting a position of the CO₂ nozzle relative to the sample. The electronic controller is configured to control the laser scanning system to cause the laser spot to follow a defined machining path on the surface of the sample and to control the CO₂ nozzle movement stage to cause the CO₂ spot to follow the defined machining path on the surface of the sample. The movement of the CO₂ spot is controllably synchronized with the movement of the laser spot.

Other aspects of the invention will become apparent by consideration of the detailed description and accompanying drawings.

### BRIEF DESCRIPTION OF THE DRAWINGS

FIG. 1A is a perspective view of a laser etching system including a material detection mechanism in accordance with one embodiment.

FIG. 1B is a block diagram of a control system of the laser etching system of FIG. 1A.

FIG. 2 is a flowchart of a method for detecting a material composition of a specimen using the system of FIGS. 1A and 1B.

FIG. 3 is a graph illustrating the surface of the specimen in image data by the system of FIGS. 1A and 1B during the performance of the method of FIG. 2 before and after post-processing is applied to the captured image data.

FIG. 4 is a flowchart of a method for training the AI model used by the system of FIGS. 1A and 1B during the method of FIG. 2.

FIG. 5 is a schematic diagram of the architecture of the AI model trained in the method of FIG. 4.

FIG. 6 is a prediction table illustrating the accuracy of a trained neural network in a first example.

FIG. 7 is a graph of a learning curve of the trained neural network in the first example.

FIG. 8 is a prediction table illustrating the accuracy of a trained neural network in a second example.

FIG. 9 is a perspective view of a CO₂-assisted laser machining system according to one implementation.

FIG. 10 is a schematic diagram of the effect of laser pulse width on the size of the formed heat affected zone (HAZ) using the system of FIG. 9.

FIG. 11 is a block diagram of a control system for the CO₂-assisted laser machining system of FIG. 9.

FIGS. 12A through 12F are images of a microelectronic device after machining using the system of FIG. 9.

FIGS. 13A and 13B are graphs of energy-dispersive spectroscopy (EDS) data acquired for the lasered region of the microelectronic device in FIGS. 12A through 12F.

FIG. 14 is a flow chart of a method of operating the CO₂-assisted laser machining system of FIG. 9 for cross-sectioning of a microelectronic device.

FIG. 15 is a flowchart of a method of operating the CO₂-assisted laser machining system of FIG. 9 for cross-sectioning of a microelectronic device using a mask.

FIG. 16 is a flowchart of a method of operating the CO₂-assisted laser machining system of FIG. 9 for cross-sectioning of a microelectronic device using CO₂ as a mask.

FIG. 17 is a perspective view of a CO₂-assisted laser machining system according to another implementation.

FIG. 18 shows cross-section samples cross-sectioned performed with different parameters.

FIG. 19 shows cross-sections of samples cross-sectioned performed without CO₂ processing and cross-sectioned with CO₂ processing.

FIG. 20 shows a Gaussian beam profile of the intensity of the laser in relation to the ablation threshold.

FIG. 21 shows a schematic depiction of an exemplary masking effect on laser beam tails.

FIGS. 22A and 22B show a schematic sample orientation in relation to an incoming laser beam and a position of a hard mask.

FIG. 23 shows a schematic depiction of a CO₂ system interacting with and shielding a sample in conjunction with a laser system.

FIG. 24 shows an effect of laser beam tails on an experimental sample.

FIGS. 25A and 25B show a cross-section of an experimental sample with an artifact and without an artifact.

FIGS. 26A, 26B, and 26C show a cross-section of an experimental sample with a laser spot overlap of 60% overlap, 85% overlap, and 92% overlap.

FIG. 27 shows an exemplary contour milling pattern.

FIG. 28 shows SEM micrographs of the hierarchical surface structure of a Pt-10Ir electrode.

FIG. 29 shows secondary electron images of laser cross-sections of a control, CO₂ mask, aluminum foil mask, and CO₂ in conjunction with an aluminum foil mask.

FIG. 30 shows results from an exemplary laser cross-sectioning process at various magnifications.

FIG. 31 shows comparative, cross-section SEM images showing results of using focused ion-beams, a control, CO₂ mask, and CO₂ in conjunction with an aluminum mask.

FIG. 32 shows various selected regions and their height estimates of a sample of different laser-processing techniques.

### DETAILED DESCRIPTION

### System and Method for Predicting Material Composition of a Specimen

The systems and methods described herein provide, among other things, techniques for prediction of material composition of a specimen using a combination of femtosecond pulsed laser and confocal imaging as well as an AI model (e.g., a neural network) trained by the surface metrics extracted from confocal images of lasered samples. In various implementations, the systems and methods described herein provide a fast and reliable, yet affordable solution for material characterization that is much needed for proper machining of microelectronic parts for conducting inspection, failure analysis and reverse engineering. Further, by integrating the method into an automated system that uses the image processing data as feedback to control the laser system, in some implementations, the systems and methods described herein can provide a mechanism for real time end-pointing and/or parameter tuning that offers new capabilities in terms of sample preparation applications.

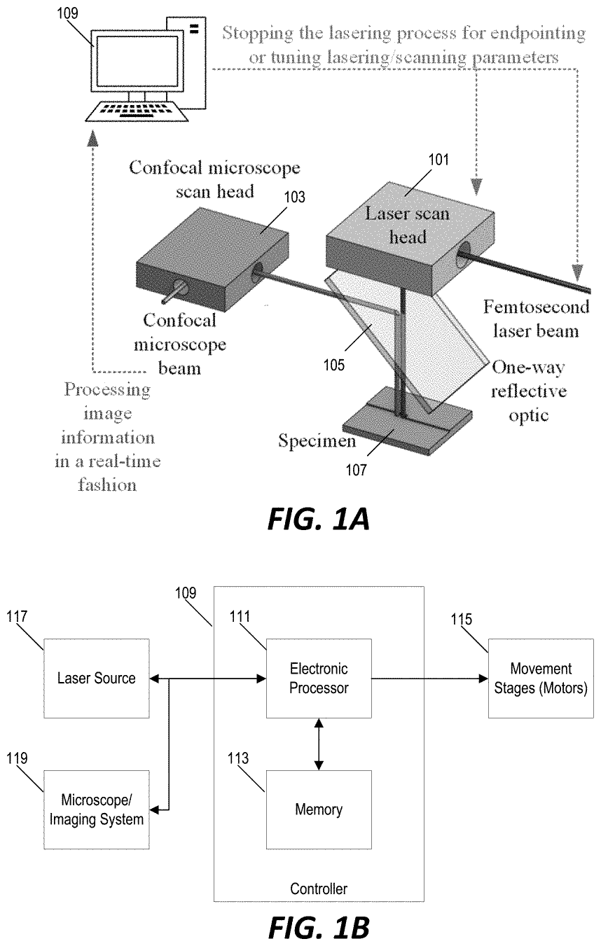

FIG. 1A illustrates an example of a system configured to detect the material composition of a specimen. The system includes a laser scan head 101 and a confocal microscope scan head 103. The laser scan head 101 receives a femtosecond-pulsed laser beam from a laser source and controllably directs the laser beam towards a surface of a specimen 107. The laser scan head 101 is configured to scan the laser beam across the surface of the specimen 107 to perform a milling of the specimen 107. Light reflected from the surface of the specimen 107 during the milling operation is directed by a one-way reflective optic 105 towards the confocal microscope scan head 103. The confocal microscope scan head 103 captures and directs the captured light from the surface of the specimen to a microscope imaging system configured to capture and record image data of the surface of the specimen 107. The confocal microscope scan head 103 is configured to move relative to the specimen 107 so that the field of view of the microscope imaging system follows the laser beam as the laser scan head 101 moves the projected laser beam across the surface of the specimen 107.

As illustrated in FIG. 1B, a system controller 109 includes an electronic processor 111 and a non-transitory computer-readable memory 113. The memory 113 stores data and computer-executable instructions that are accessed and executed by the electronic processor 111 to provide the functionality of the system controller 109 (including, for example, the functionality described herein). The system controller 109 is communicatively coupled to a plurality of movement stages 115 and is configured to generate and transmit control signals to the movement stages 115 to control movement of the confocal microscope scan head 103 and the laser scan head 101. The system controller 109 is also communicatively coupled to the laser source 117 and is configured to generate and transmit control signals to the laser source 117 to define and adjust parameters of the laser beam emitted by the laser source 117. Similarly, the system controller 109 is communicatively coupled to the microscope/imaging system 119 and is configured to receive image data of the surface of the specimen 107 from the microscope/imaging system 119.

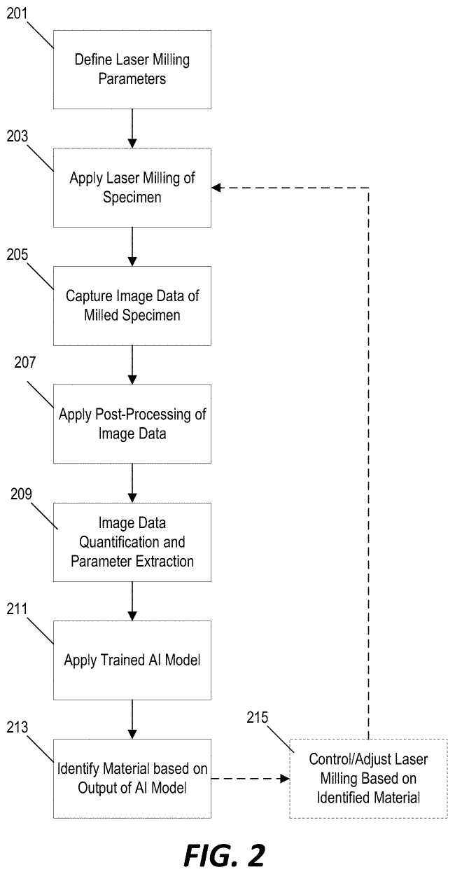

FIG. 2 illustrates an example of a method performed by the system controller 109 to determine a material composition of the specimen 107. First, the system defines laser milling parameters (step 201) based, for example, on user input and/or stored data. The laser source 117 and the movement stages 115 of the laser scan head 101 are operated by the system controller 109 to apply a laser milling to the specimen 107 (step 203). Lasering may be performed using a femtosecond (fs) pulsed laser source with, for example, 40 Watt (W) average power, 1053 nanometer (nm) wavelength, and 257 fs pulse width. The laser system includes a galvo scanner to raster the beam and a three-axis stage with sub-micron accuracy for positioning. An F-theta lens with a 70 mm focal distance is attached to the scanner, resulting in an approximately 15-um diameter spot size. As the laser milling is applied, the system controller 109 receives and records image data of the milled specimen 107 from the microscope/imaging system 119 (step 205). The system controller 109 applies one or more post-processing routines to the captured image data (step 207) and then analyzes the captured image data to quantify and extract parameter metrics of the specimen surface (step 209). A trained AI model is then applied (step 211). For example, in some implementations, the trained AI model is configured to receive as input the values of one or more laser scanning parameters and/or one or more surface texture parameters extracted from the captured image data and, in response, to produce as output an indication of a material composition. Based on the output of the AI model, the system controller 109 identifies the material composition of the specimen surface (step 213).

In some implementations, the system controller 109 is only configured to capture and process the image data in order to identify the material composition of the specimen. In other implementations, the system controller 109 is configured to use the identification of the material composition as feedback to control/adjust the laser milling based on the identified material at the surface of the specimen 107 (step 215). For example, in some implementations, the system of FIG. 1A and system controller of FIG. 1B are incorporated into a laser milling system for accessing and inspecting an interior of a microelectronic device (e.g., an integrated circuit package). The microelectronic device may include multiple different layers, each formed of a different material. In some implementations, the system may be configured to stop the etching process when the laser machining progresses through a first layer and reaches another layer (e.g., an “end-stop” layer). Accordingly, by identifying the material composition at the surface of the specimen, the system controller 109 is able to detect when the milling process has reached the “end-stop” layer and is configured to stop the milling process in response to detecting the change in material composition. Similarly, in some implementations, the laser milling process can be optimized by adjusting the laser parameters for different types of materials. Accordingly, in response to identifying the material composition at the surface of the specimen, the system controller 109 can adjust the laser parameters to a set of parameters corresponding to the identified material type. In some implementations, when the system controller 109 detects that the material composition has changed, the system controller 109 can similarly change the laser parameters for the continued milling operation.

Table 1 illustrates a list of examples of laser machining parameters that, in some implementations, can be adjusted by the system controller 109. Additionally, in some implementations, the trained AI model may be configured to receive some or all of the laser machining parameters listed in Table 1 as input along with quantified surface texture parameters extracted from the captured image data.

TABLE 1
Laser Machining Parameters

| Parameter | Description |
|---|---|
| Effective spot size | Spot size at the interface |
| | with the sample's surface |
| Energy per pulse | Energy per pulse |
| (EPP) | |
| Pulse mode | Normal/Burst |
| Repetition rate | Number of pulses per |
| | second |
| % X Overlap | Overlap between |
| | consecutive laser pulse |
| | spots in X direction |
| % Y Overlap | Overlap between |
| | consecutive laser pulse |
| | spots in Y direction |
| Redeposition | Method to mitigate |
| control mode | redeposition of ablated |
| | material debris onto the |
| | surface (None/Air) |
| Scan pattern | Laser scanning path on |
| | the surface |
| Number of cycles | Number of consecutive |
| | times the surface is |
| | scanned with a certain |
| | pattern |
| Surface pre- | Surface geometry of the |
| machining | surface prior to the laser |
| | machining experiment |

Table 2 illustrates a list of examples of surface texture parameters that, in some implementations, can be extracted and quantified from the captured image data. In some implementations, the AI model is trained to receive some or all of the surface texture parameters listed in Table 2 as input. In other implementations, the AI model may be trained to receive as input other parameters extracted from the captured image data in addition to or instead of those listed in Table 2. Furthermore, although, in some implementations, the AI model is configured to receive as input a combination of laser milling parameters and surface parameters extracted from the image data, in other implementations, the AI model is configured to receive as input only parameter data extracted from the captured image data. In still other implementations, the AI model may be trained to receive the image data itself as input.

TABLE 2
Extracted Surface Texture Parameters

| Parameters | Description |
|---|---|
| DOC | depth of cut |
| Sq | root mean square height of the |
| | surface |
| Sal | fastest decay auto-correlation rate |
| Ssk | skewness of height distribution |
| Str | texture aspect ratio of the surface |
| Sku | kurtosis of height distribution |
| Std | texture direction of the surface |
| Sp | maximum height of peaks |
| Sdq | root mean square gradient of the |
| | surface |
| Sv | maximum height of valleys |
| Sdr | developed area ratio |
| Sz | maximum height of the surface |
| Smr | surface bearing area ratio |
| Sa | arithmetical mean height of the |
| | surface |
| Sdc | height of surface bearing area |
| | ratio |
| Spd | density of peaks |
| Sxp | peak extreme height |
| Spc | arithmetic mean peak curvature |
| Vm | material volume at a given height |
| S10z | 10-point height |
| Vv | void volume at a given height |
| S5p | 5-point peak height |
| Vmp | material volume of peaks |
| S5v | 5-point valley height |
| Vmc | material volume of the core |
| Sda | closed dales area |
| Vvc | void volume of the core |
| Sha | closed hills area |
| Vvv | void volume of the valleys |
| Sdv | closed dales volume |
| Shv | closed hills volume |

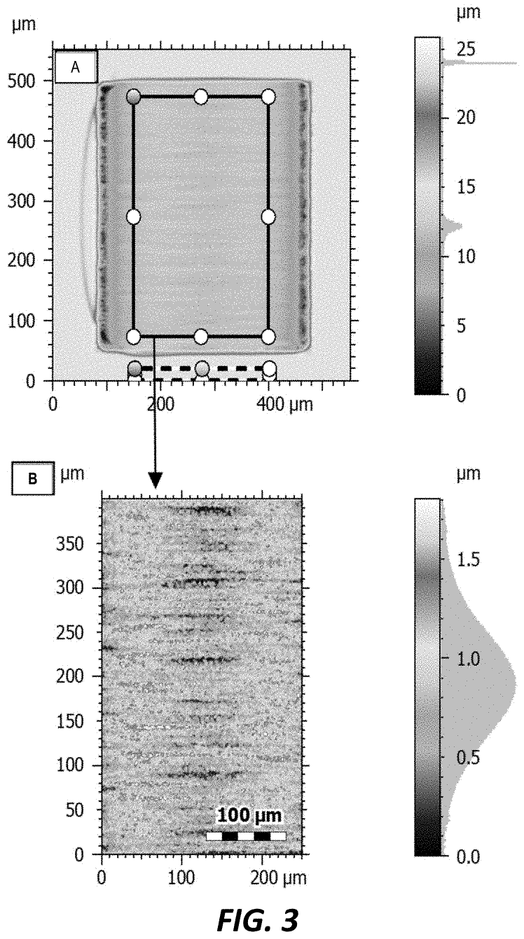

FIG. 3 illustrates an example of an image of the surface of the specimen captured by the system of FIG. 1A and system controller of FIG. 1B both before post-processing is applied (Graph A) and after post-processing is applied (Graph B). In this example, the acquired image data is prepared for the parameter quantification/extraction steps by applying post-processing using Digital surf Mountains software to perform the following sequence of steps: (1) fill non-measured points, (2) remove outliers, (3) level the data, (4) filling non-measured points again, and (5) thresholding to remove foreign objects. Graph A of FIG. 3 displays an initial imaged region and Graph B of FIG. 3 depicts the final extracted lasered area after post-processing. Surface texture parameters are extracted from the Graph B image data and depth of cut information (i.e., the depth to which the laser cut into the specimen material) is obtained by subtracting the average height of the lasered area from the average height of the non-lasered area.

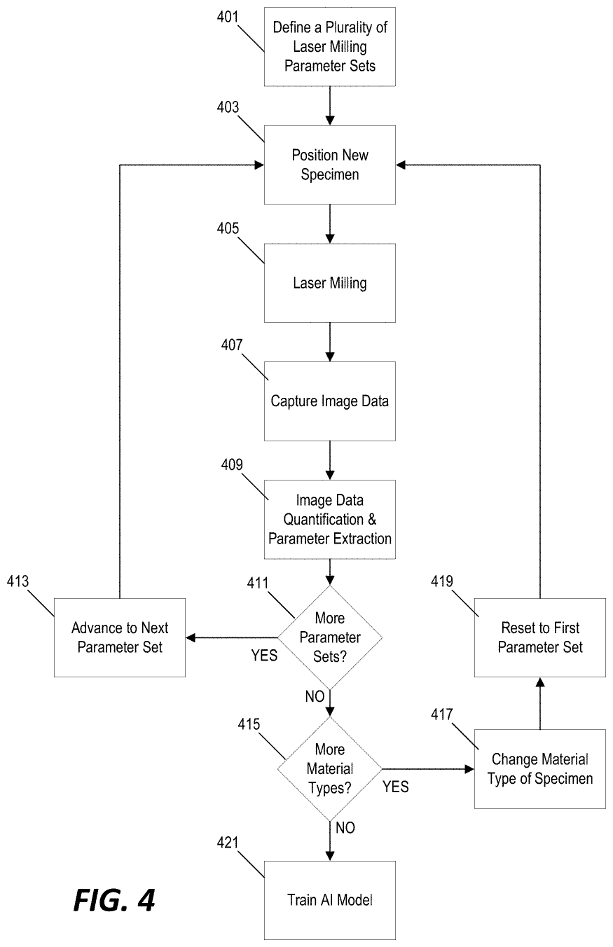

FIG. 4 illustrates an example of a method for training the AI model that is used by the system in the method of FIG. 2 to identify the material composition of the surface of the specimen 107. In the method of FIG. 4, the training data is assembled by applying a plurality of laser milling parameter sets each to a plurality of different material types. First, the laser milling parameter sets are defined (e.g., by user input, automatically generating a plurality of parameter sets, or accessing stored parameter sets from the memory 113) (step 401). After the laser milling parameter sets are defined, a new specimen is positioned within the laser chamber (step 403). The specimen may be positioned onto a vacuum chuck for sample stability. Laser milling is applied according to a first parameter set of the plurality of parameter sets (step 405) while image data is captured (step 407). A vacuum system may be used to collect debris. A confocal laser scanning microscope (CLSM) may be used to capture the image data. The field of view (FOV) of the microscope may be selected to cover both a laser-machined area and an in-tact area of the specimen. For example, the FOV may be selected as 520 by 520 microns. However, the FOV may be adjusted according to the size of the lasered area.

The captured image data is analyzed to quantify and extract surface texture parameters from the image data (step 409). In some instances, post-processing is applied to the captured image data. The quantified and extracted surface texture parameters are then stored to memory along with an indication of the known material composition of the specimen and an indication of the laser machining parameter set used on the specimen. The system then advances to the next parameter set in the plurality of parameter sets (step 413) and another new specimen of the same material composition is positioned (step 403). Laser milling is then performed on the new specimen of the same material composition using the new parameter set (step 405) while image data is captured (step 407) and surface texture parameters are extracted from the captured image data (step 409). This process is repeated until all of the different parameter sets have been used to machine specimens of the first material composition (step 411).

After all of the parameter sets have been used to machine specimens of the first material type, the material type of the specimen is changed (step 417) and the process is repeated for specimens of the next material type beginning by resetting the machine system to the first parameter set (step 419). When all of the parameter sets have been used to machine specimens of the second material composition type (step 411), the material type of the specimen is changed again (step 417) until all of the parameter sets have been used to machine specimens of each of the plurality of different specimen types (step 415).

After all of the parameter sets have been used to machine specimens of all of the different material compositions, the training data set is complete and the collected data is used to train the AI model (step 421). The input of each training data point of the AI model includes lasering and scanning parameters used for lasering the surface, as well as the surface metrics extracted from the confocal images of the lasered surfaces. For example, in the example of FIG. 4, the training data set stored to the memory 113 includes a set of surface texture parameters extracted from image data in each experiment, an indication of the material composition of the specimen, and an indication of the laser machining parameter set used on the specimen in the captured image data. Accordingly, the AI model may be trained to receive as input some or all of the laser machining parameters and some or all of the surface texture parameters extracted from the image data and to produce as output, in response to the provided input, an indication of the known material composition corresponding to the specimen in the image data captured during the training method of FIG. 4. In some instances, redundant parameters are not provided as input to the AI model. For example, the set of parameters “X % overlap”, “scanning speed” and “repetition rate,” may include only two independent quantities such that having two out of three parameters determined, the third quantity will collapse to only one possible value. Therefore, one parameter (e.g., speed) may be excluded from the input parameters for the training data point.

Training parameters may be selected based on capability of distinguishing material type, and among two sets of parameters with comparable capability to distinguish among material types, the set with fewer number of elements is chosen to promote simplicity.

The AI model may be, for example, a five-layer fully connected neural network for predicting the material type from the lasering and scanning parameters and surface metrics. During training, the scanning pattern feature is coded using integer numbers 1 through 6, respectively representing bidirectional lines, cross, multiangle (45°), dot, hexagon, and contour patterns. The material type is coded by numbers 1, 2, and 3, respectively representing Aluminum, Silicon, and Copper. For the rest of the features, the real values of the quantities were used without normalization.

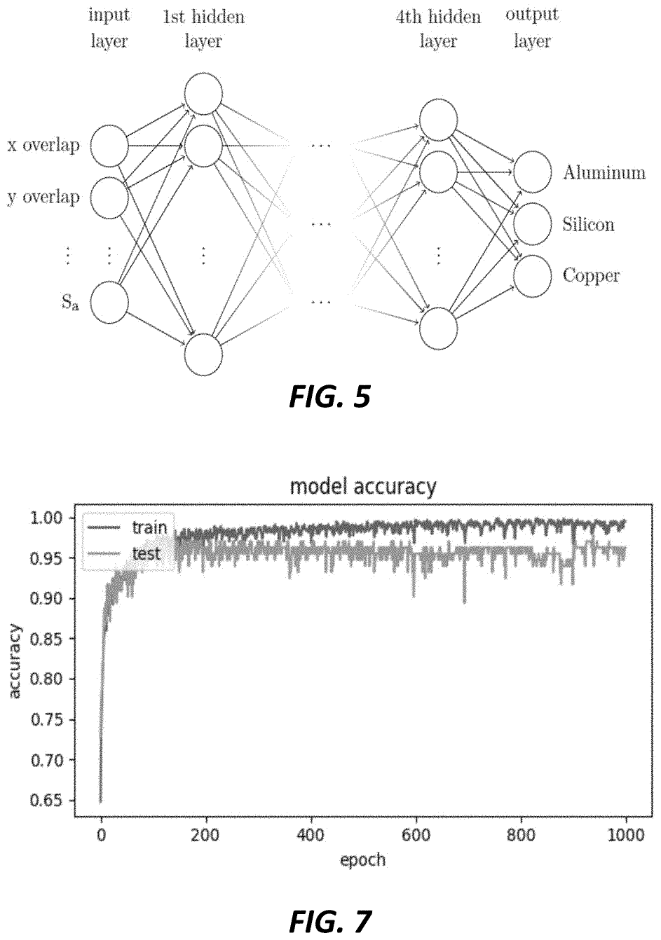

In some instances, the training of the AI model includes the use of one or both of a rectified linear unit activation function or a Softmax function. For example, a rectified linear unit activation function may be used in every layer except for the last layer, and a Softmax function may be used in the last layer. Biases and weights may be initialized randomly to [−1,1] interval. The input dataset may be randomly split into a training dataset and a testing dataset. For example, 80% of the input dataset may be included in the training dataset, and 20% may be included in the testing subset. The AI model may be trained using the training dataset for a predetermined number of epochs (e.g., 1000 epochs). The trained AI model is then used for making predictions on the testing dataset. The architecture of the trained neural network is shown in FIG. 5.

After training, the AI model may be applied to data captured for new specimens having unknown material composition. The AI model trained by the method of FIG. 4 is configured to receive as input one or more laser machining parameters and one or more surface texture parameters extracted from the captured image data of the machined specimen and to produce, as output, an indication of the predicted material composition of the specimen.

FIGS. 5 through 8 illustrate examples of experiments used to train an AI model using the method of FIG. 4, and to then test the trained model by applying the model to other image data. In the illustrated example, a total of 1,679 samples of three different material composition types (i.e., aluminum, silicon, and copper) are used. However, more than 1,679 samples or less than 1679 samples may be used. Additionally, the number of material composition types are not limited to three, and may be more than three or less than three. Aluminum, silicon, and copper are often found within microelectronics, and are typically the driving force behind the resulting finish of failure analysis techniques. However, the material compositions used are not limited to aluminum, silicon, and copper.

In the illustrated examples, the surface texture parameters selected for training the AI model include depth of cut (DOC), roughness (Sq), Max height (Sz), and mean height Sa. However, more or fewer parameters may be selected. An output of each training data point reflects the material type of the lasered sample, which is known based on controlled experiments performed to capture the training data.

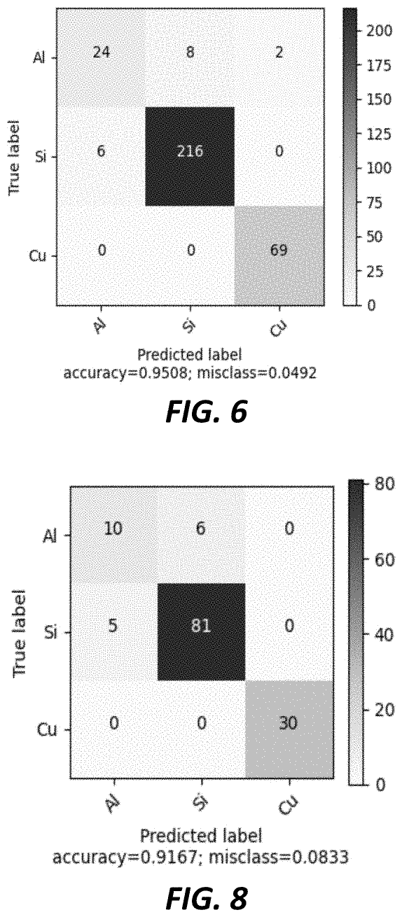

FIG. 6 illustrates example results of the accuracy testing of the trained AI model. For example, of 325 testing trials, 34 are Aluminum, 222 are Silicon, and 69 are Copper. As illustrated in FIG. 6, testing accuracies are 70% (24 out of 34) for Aluminum, 97% (216 out of 222) for Silicon, and 100% (69 out of 69) for Copper. FIG. 7 shows a learning curve for the training and test data.

Table 3 lists example probability values associated with predictions by the AI model for different material types. The data included in Table 3 indicates that all mispredictions are the result of the AI model determining Aluminum instead of Silicon and vice versa. This may be due to the closeness of the atomic numbers of Silicon and Aluminum, 14 and 13 respectively, potentially resulting in similar behavior in interaction with the laser.

TABLE 3
Mispredictions and corresponding probabilities

| Material | pAl | pSi | pCu |
|---|---|---|---|
| Al | 0.48 | 0.52 | 0.00 |
| Al | 0.00 | 1.0 | 0.00 |
| Al | 0.00 | 1.0 | 0.00 |
| Al | 0.00 | 1.0 | 0.00 |
| Si | 0.99 | 0.01 | 0.00 |
| Si | 0.99 | 0.01 | 0.00 |
| Si | 0.90 | 0.10 | 0.00 |

The depth of cut and Sq values for one set of experimental conditions have been reported for each of the three material types used in this experiment in Table 4.

TABLE 4
Depth of cut and Sq values for one set of experimental
conditions, for the three material types

Experimental conditions
Scanning Speed: 1.5 m/s;
X overlap: ~88%;
Y overlap: ~85%;
Lasering pattern:
bidirectional lines;
Redeposition control: absent;
Number of lasering cycles: 1;
Energy per pulse: ~1750 J;
Repetition rate: 0.5 MHz;
Burst mode: N/A;

| | Depth of cut | |
|---|---|---|
| Material type | (μm) | Sq (μm) |
| Silicon | 0.60 | 0.12 |
| Aluminium | 0.79 | 0.31 |
| Copper | 0.21 | 0.57 |

Although a rather large FOV (520 μm×520 μm) is chosen for analysis in this example, the analysis area can be significantly shrunken in other implementations to increase the resolution of the method in distinguishing multiple types of material that are present in one layer. The limit on the extent of such shrinking would be enforced by the lateral resolution of the confocal microscope which is sub-micron. Therefore, in principle, the area for analysis can be 500 to 1000 times smaller, in each lateral dimension, than what is currently demonstrated.

Additionally, another experiment was performed to demonstrate whether depth of cut alone can distinguish different material types. The ability to do so enables some systems and implementations to utilize a simple height sensor setup and a feedback system for end-pointing/parameter tuning (e.g., instead of a more complex microscope/imaging system). For this example, a second AI model may be trained on a smaller subset of data from the original set of experiments, and the second AI model is applied to other data to test the accuracy of the trained AI model. The results are illustrated in the prediction table of FIG. 8 and demonstrate that the depth of cut alone can accurately predict copper, but is less accurate in distinguishing aluminum and silicon. However, increasing the training data may improve the accuracy of an AI model that is trained on depth of cut alone.

In these examples, along with the lasering/scanning parameters that are set by the user, only four surface texture parameters (DOC, Sq, Sz, and Sa) are utilized in training the AI model to predict the material composition of a specimen. However, in some other implementations, the AI model may be trained using the entire image instead of these derived parameters, which can potentially reveal more information about the surface and thus provide more accurate predictions. Additionally, although the examples described herein utilize a confocal microscope imaging system, other implementations may utilize different imaging modalities including, for example, scanning electron microscopy. Finally, in the example described above, the AI model is trained to identify a material composition of a specimen as a single material type (e.g., silicon, copper, or aluminum). In other implementations, the AI model may be trained to identified mixed-material compositions.

### System and Method of Laser Machining Specimens with CO₂ Gas Assisted Processing

A CO₂ gas delivery system can be used in tandem with laser processing. Laser processing can include laser machining, laser surface texturing, laser scribing, and laser milling.

This disclosure provides a significant increase in efficient particle removal and prevention of redeposition through the timing and location of the laser drilling pulse relative to the CO₂ pulse. The removal saves the end user a significant amount of time when it comes to both the building process and the actual processing time of the material. This also reduces the amount of original material needed for processing, saving money and allowing one-of-a-kind samples to be used. The disclosure enables pristine laser finishes which can be applicable to laser cross-sections, a new application with a large impact in failure analyses.

In various embodiments, a laser cross-sectioning method and system is provided. The laser cross-sectioning method and system address the throughput challenges associated with focused-ion beam (FIB) methods in combination with precision challenges associated with mechanical and chemical etching methods. In various embodiments, the laser cross-sectioning method and system include a femtosecond laser assembly and a targeted CO₂ gas delivery system. In various embodiments, the combination of the femtosecond laser assembly and the targeted CO₂ gas delivery system provides redeposition control and beam tail curtailing, and a hard mask that provides a smaller effective spot which achieves improved qualities in the laser cross-sectioning. The combination of CO₂ gas injection and hard masking may result in improved high-quality cross sections in comparison to focused-ion beam (FIB) cross sections. In various embodiments, the laser cross-sectioning method and system may provide multiple orders of magnitude of increased speed in comparison to cross-sections prepared by focused-ion beams (FIB) methods. Exemplary laser cross-sectioning methods and systems may provide improved throughput inspections at a significantly reduced cost in comparison to focused-ion beams (FIB).

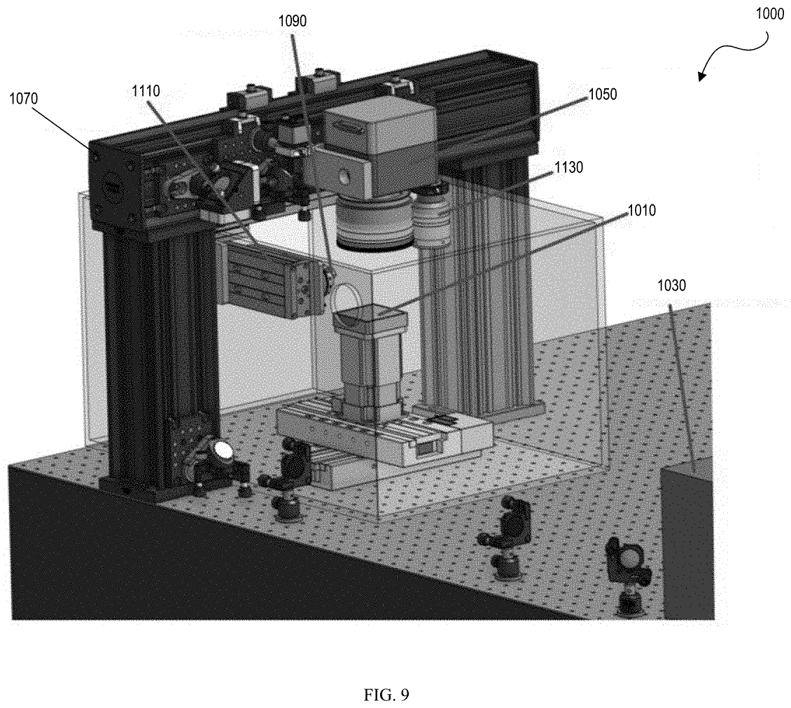

FIG. 9 illustrates an example of an intelligent machining system 1000 that combines a femtosecond pulsed laser with a synchronized CO₂ injection system that, in some implementations, is configured to provide fast, clean, high aspect ratio cross-sectioning of microelectronic parts. The system 1000 in this example has been developed for providing high-precision and high-throughput machining for material removal (e.g., for intrusive inspection of electronic components) involving tasks such as sample preparation, delayering, and de-packaging of micro/nano-scale electronics. A laser source 1030 is positioned to emit a controlled laser beam through a sequence of optical devices (e.g., lenses, filters, and/or mirrors) that deliver the laser beam from the laser source 1030 to a scan head 1050. The scan head 1050 controllable projects the laser beam to a sample (e.g., a microelectronic device IC) positioned on a sample stage 1010.

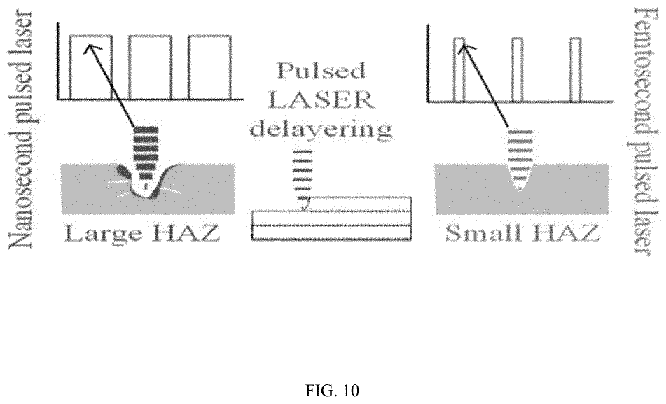

In some implementations, the laser source 1030 includes a femtosecond pulsed laser. For example, the laser source 1030 may include a Coherent Monaco laser system with 40 W average power, 1035 nm wavelength, and 257 femtosecond pulsed width. As illustrated in FIG. 10, femtosecond pulsed lasers cause minimal to zero heat affected zone (HAZ) and, therefore, are well-suited for fine machining of microelectronic parts when throughput is also an important consideration.

In the example of FIG. 9, the sample stage 1010 is configured as a three degree-of-freedom stage (e.g., a Zaber Technologies 3-DOF stage) that has sub-micron translational accuracy for highly precise alignment of the to-be-machined surface with the laser beam and precise focusing/defocusing of the laser beam. As illustrated in FIG. 9, the sample stage 1010 includes a platform (where the to-be-machined sample is placed) positioned on top of a z-stage pillar. The z-stage pillar is configured to controllably adjust a position of the sample platform in the z-direction (e.g., up, and down). The z-stage pillar is coupled to a y-stage track that includes an actuation mechanism (e.g., an electric motor) for adjusting a position of the pillar (and the sample positioned thereon) in the y-direction (e.g., back, and forth). Finally, the y-stage track is coupled to an x-stage track that also includes an actuation mechanism (e.g., an electric motor) for adjusting a position of the y-stage track, the z-stage pillar, and the sample positioned thereon in the x-direction (e.g., left, and right). Accordingly, the sample stage 1010 is configured to adjustably position a sample on the sample platform in the x, y, and z directions.

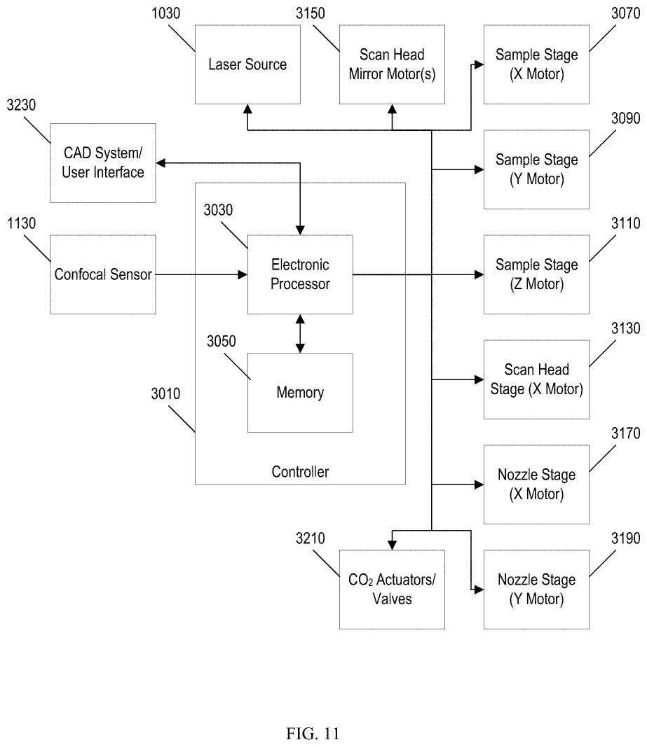

The sample stage 1010 also enables fixed beam laser ablation scheme and further is synchronized with the scan head 1050 through a machining controller (described below in reference to FIG. 11) for implementing hybrid machining in which concurrent movement of the sample stage 1010 and the scanning head 1050 will further increase the scanning rate of the machining system 1000. The scan head 1050 is coupled to a support arm track 1070 configured to adjust a position of the scan head 1050 in the x-direction. The scan head 1050 also includes one or more controllable mirrors, lenses, and/or other optical devices configured for controllably lasering and focusing the laser beam (from the laser source 1030) on the machining plane (i.e., a target plane corresponding to the sample placed on the sample platform of the sample stage 1010). n some implementations, the scan head 1050 includes a Scanlabs Basicube10 galvo scanner and a Q-optic F-⊖ lens.

In some implementations, the machining system 1000 of FIG. 9 also includes an acousto-optic modulator (AOM) integrated, for example, into the laser source 1030 or the scan head 1050. The AOM is configured to rapidly and controllably shutter the laser beam for enabling the clean movement of the beam from one location to another without damaging the surface. The AOM is used to start and finish the machining process and to enable jumping from one area of the sample to another. In some implementations, the response time of the AOM is faster than 50 ns.

The machine system 1000 also includes a confocal sensor 1130 (e.g., a Keyence confocal sensor) positioned adjacent to (or coupled to) the scan head 1050 and positioned with a downward facing field of view (e.g., aimed at the sample platform of the sample stage 1010 from above). The confocal sensor 1130 is configured to collect height information from the surface of the sample positioned on the sample platform of the sample stage 1010. This height information is then used as feedback information for tuning the laser machining parameters. In some implementations, because the confocal sensor 1130 is coupled to the scan head 1050, the position of the confocal sensor 1130 relative to the scan head 1050 is known. Using this known relationship, the system is able to use the height information captured by the confocal sensor 1130 to map the surface of the sample in the same coordinate frame used by the scan head 1050 for the laser machining process.

The machining system 1000 of FIG. 9 includes a CO₂ nozzle 109 coupled to the support arm 1070 by a nozzle extension arm 1110. The nozzle extension arm 1110 is configured to controllably adjust a position of the CO₂ nozzle 1090 in the y-direction by extending and retracting the nozzle extension arm 1110 and to controllably adjust a position of the CO₂ nozzle 1090 in the x-direction by moving the nozzle extension arm 1110 along a track of the support arm 1070. In some implementations, the CO₂ nozzle 1090 is configured to deliver a CO₂ gas to the machining area by controllable targeting of the CO₂ nozzle 1090. OAs described in further detail below, in some implementations, the machining system 1000 may be configured to cause the CO₂ nozzle 1090 to follow the same scan pattern as the laser beam. A relatively large spot size of the CO₂ nozzle 1090 and the corresponding injection system allows for compensating the lower accuracy of the 2D movement system of the CO₂ nozzle 1090 for achieving higher speeds.

When performing laser machining using a femtosecond laser pulse width, the particle size of material removed from the sample during the machining process can range from nanometer-scale to small micrometer-scale. This removed material in many cases redeposits itself onto the surface of the sample itself. This redeposition can then interfere with future processing and can cause many complications including, for example, slowed rate of material removal, limits in depth due to the aspect ratio of the processed area, and difficulty in developing optimized laser and scanning parameters used in the process. In some implementations, air guns (e.g., a nozzle emitting pressurized air) can be used to blow the debris from the surface. However, air guns require particle drag to remove the redeposited particles and, if the size of the particle is less than approximately 5 microns, there cannot exist enough drag force to remove this particle from the surface.

Accordingly, in some implementations, a CO₂ delivery system associated with the CO₂ nozzle 1090 is configured to convert CO₂ gas to three phases to benefit from unique features of each phase. CO₂ applied to the sample in the liquid phase eliminates hydrocarbon as it is an excellent solvent. CO₂ applied to the sample in the gas phase can be used to blow debris from the surfaces of the sample. And CO₂ in the solid phase (i.e., CO₂ “snow”) can be controllably applied to the sample surface to remove particle debris generated by the laser machining process that are connected to the sample surfaces by Van der Waal forces. Accordingly, the use of the CO₂ delivery system in tandem with the laser processing in the machining system 1000 of FIG. 9 provides: (1) enhanced wall quality in the machined cross-sections, (2) improved surface quality in terms of surface roughness, (3) enhanced machined depth, (4) reduced collateral damage (e.g., a reduced or eliminated HAZ), and (5) substantially less permanent (e.g., Van der Waal-bonded) debris/particulates.

FIG. 11 illustrates an example of a control system for the machining system 1000 of FIG. 9. A machining controller 3010 includes an electronic processor 3030 and a non-transitory computer-readable memory 3050. The memory 3050 stores data and computer-executable instructions that are accessed and executed by the electronic processor 3030 to provide the functionality of the machining controller 3010 (including the functionality described herein). The machining controller 3010 is communicatively coupled to a plurality of electric motors that facilitate the controlled movement of the sample stage 1010, the scan head 1050, and the CO₂ nozzle 1090. For example, the machining controller 3010 generates and transmits control signals to an x-motor 3070, a y-motor 3090, and a z-motor 3110 of the sample stage 1010 to control positioning of a sample positioned on the sample platform of the sample stage in 3D space. The machining controller 3010 also generates and transmits control signals to an x-stage motor 3130 for the scan head 1050 to controllably adjust a position of the scan head 1050 in the x-direction and to one or more additional electric motors 3150 that control the positioning/orientation of the mirror(s) of the scan head for controllably scanning the laser beam on the surface of the sample. Finally, the machining controller 3010 generates and transmits control signals to an x-motor 3170 and a y-motor 3190 of the nozzle extension arm to control positioning of the CO₂ nozzle 1090 in a two-dimensional plane above the sample stage 1010.

In this way, the machining controller 3010 can controllably synchronize movement of the CO₂ nozzle 1090 and the projected laser beam relative to the sample to cause the CO₂ nozzle 1090 to emit CO₂ along the same path as the laser machining. The machining controller 3010 is also communicatively coupled to the laser source 1030 and the actuators/valves 3210 of the CO₂ system and is configured to generate and transmit control signals to regulate the laser beam and the CO₂ applied to the sample. Accordingly, the machining controller 3010 is configured to controllably synchronize the location of the laser spot on the surface of the sample in tandem with the CO₂ jet spot and applies an appropriate time delay between the two to avoid interaction of the laser beam with the CO₂ spot. In some implementations, the machine controller 3010 is also configured to generate and transmits control signals to the laser source 1030 to cause the laser source to adjust various parameters of the laser beam (e.g., on/off, frequency, power/amplitude, pulse width) and to generate and transmit control signals to the actuators and valves 3210 of the CO₂ system to control adjust various parameters of the emitted CO₂ (e.g., on/off, pressure of CO₂ jet, state of CO₂ jet, etc.). The machining controller 3010 is also communicatively coupled to the confocal sensor 1130 and configured to receive a signal output from the confocal sensor indicative of surface heights of the sample relative to a coordinate frame used by the machining system 1000 and to adjust the operation of the machining system 1000 accordingly (e.g., by raising/lowering the platform of the sample stage 1010, adjusting an angle of the scan head 1050, etc.).

The machining controller 3010 is also communicatively coupled to a user interface 3230 including a display device and one or more user input devices (e.g., a keyboard, mouse, etc.). The user interface 3230 is configured to receive various operating instructions and parameters from a user. In some implementations, the user interface 3230 includes a computer-assisted design system that is configured to receive inputs from a user defining parameter of the machining to be performed by the machining system 1000 (e.g., position, size, pattern, depth, etc.). In some implementations, the user interface 3230 is also configured to receive user instructions defining the state of matter of the CO₂ to be used during the machining process. In some implementations, the user interface 3230 allows the user to define different states of matter for the CO₂ to be used at different stages of the machining process (e.g., the machining process can be user-defined to emit CO₂ in gas form to “blow” debris at one step and to emit solid CO₂ snow at another step to remove Van der Waal-bonded debris from the sample).

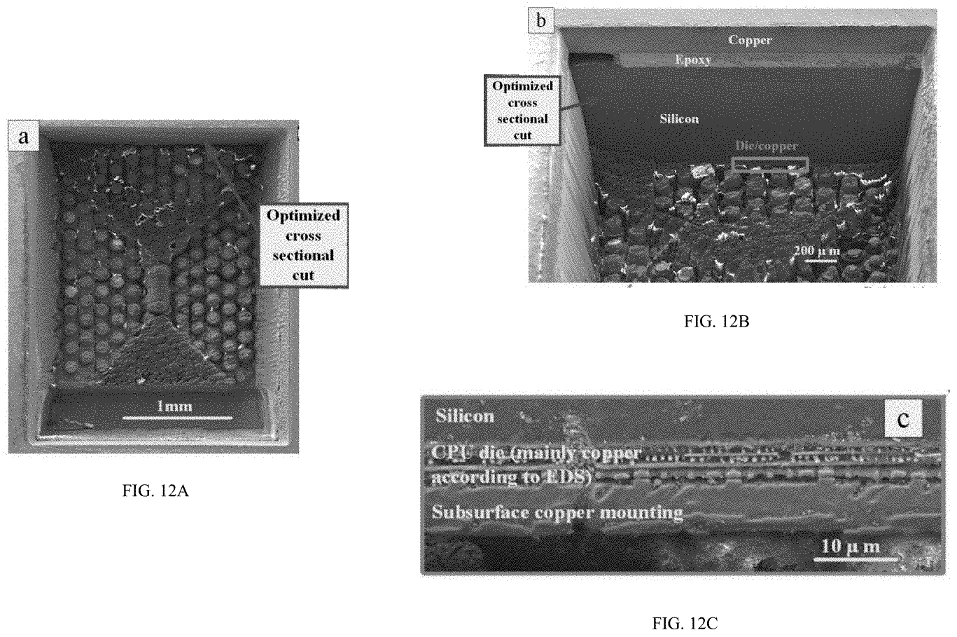

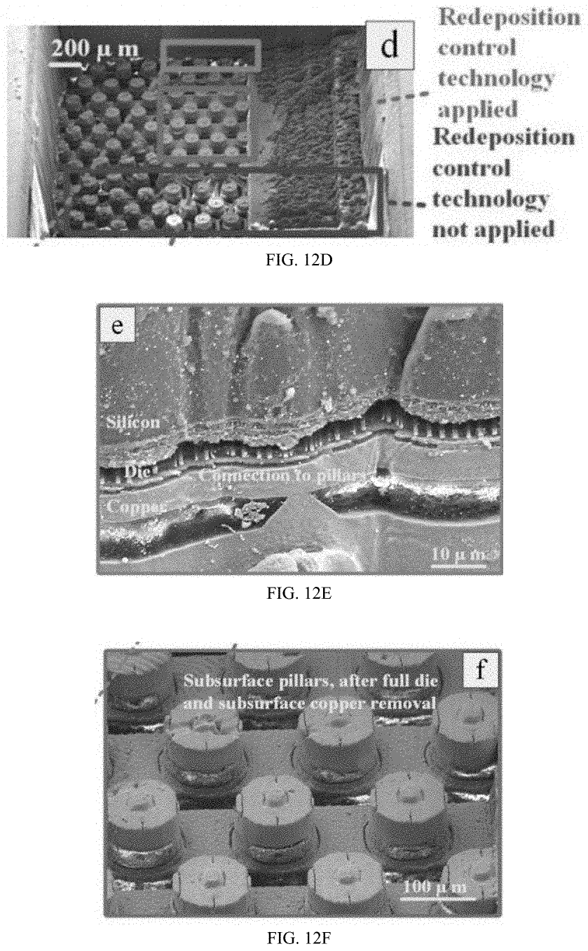

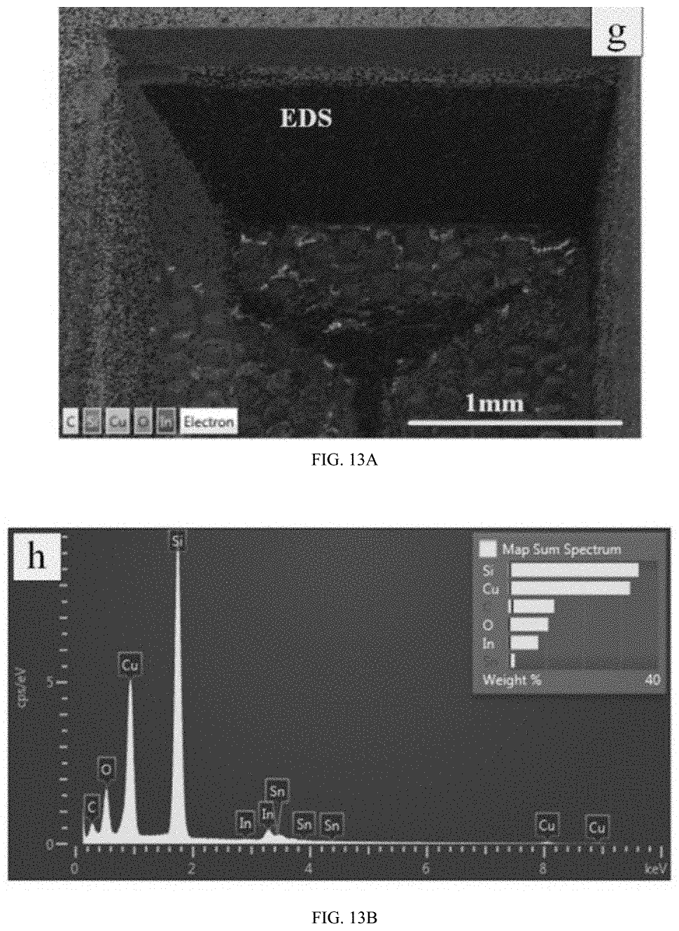

In some implementations, the fast and precise ablation capability offered by the machining system 1000 of FIG. 9 provides a unique solution for failure analysis practices. FIGS. 12A through 12F show an example of top-down and cross-sectional material removal for an Intel Xeon CPU. Effects of parameter optimization and user of redeposition control techniques are depicted in FIGS. 12A through 12F. Specifically, FIGS. 12A and 12B provide an overview of the laser processed region of the CPU showcasing the superiority of the proposed technique over FIB with regards to creating deep trenches. FIG. 12B provides a view of the wall with optimized laser parameters and targeted gas injection system. It can be seen that bulk material removal has taken place through three layers: copper, epoxy, and silicon. FIG. 12C provides a view of the die layer and FIG. 12D provides a view of the pillars that are located underneath the die layer, showcasing the ability of the machining system 1000 to expose buried structures for inspection in a rapid fashion (e.g., minutes vs. days). As is evident from this example, redeposition control technology, which is enabled by the CO₂ injection system, has dramatically improved the quality of the cut where is has been used versus where is has been absent. FIG. 12E provides a closer look at the cross section of the die layer and FIG. 12F provides a closer look at the pillars where redeposition control technology has been applied. FIGS. 13A and 13B show EDS data acquired for the lasered region of the device in FIGS. 12A through 12F.

The systems and methods described in the examples above provide mechanisms for a tunable approach to laser machining in which a user can customize/tune the laser parameters and the CO₂ parameters utilized throughout the laser machining process. The system is also configured to synchronize the movement of the laser spot and the CO₂ spot on the sample to provide controlled clearing of debris from the machining process without undesired interference between the laser beam and the CO₂. In various implementations, the machining system 1000 may be used for machining with or without a “mask” and, in some implementations, the CO₂ system itself can be operated to create a CO₂-based mask on a surface of the sample for the lasering process.

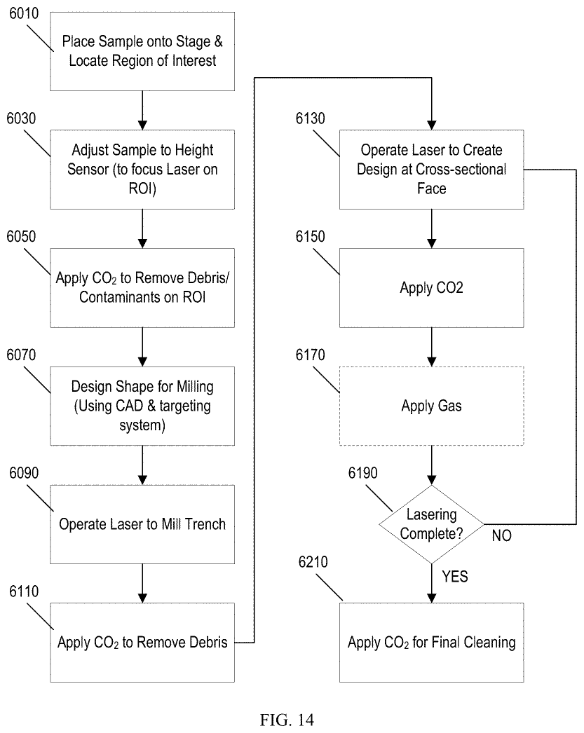

FIG. 14 illustrates an example of a method for operating the machining system 1000 to performing laser machining without the use of a mask. The sample is placed on the sample stage 1010 and a region of interest of the sample is located (step 6010). The sample stage 1010 is operated to adjust the position of the sample and to properly focus the laser beam on the identified region of interest (step 6030). CO₂ is emitted from the CO₂ nozzle 1090 to remove debris and/or contaminants from the region of interest (step 6050). In some implementations, the position of the CO₂ nozzle 1090 is controllably adjusted to “scan” the CO₂ spot across the region of interest and, in order to increase the degree of cleaning provided, the system can be operated to scan the CO₂ spot across the region of interest multiple times. The CAD system 3230 and the targeting system (e.g., data received from the confocal sensor 1130) are used to create a shape for marking the region of interest (e.g., the machining to be performed) (step 6090).

In some implementations, it is possible to achieve a cross-section with a single laser line and the CO₂ system greatly reduces aspect ratio issues that would occur with an FIB-based system. In some implementations, utilizing a trapezoidal or other various shapes function better allowing both view of cross-section for imaging and CO₂ cleaning system. If using a rectangular or trapezoidal shape for the trench, an optical cross-section may be achieved by milling the trench first (step 6090) and, depending on the desired depth of the trench, the number of scan cycles can be adjusted. The system is then operated to apply CO₂ again to remove debris created by the trench milling and to prepare the cross-sectional face for polishing and the final steps (step 6110).

The laser system (e.g., the laser source 1030 and the scan head 1050) are then operated to create the CAD-designed marking at the cross-sectional face (step 6130). This can be a single laser line or more depending on the desired outcome. For example, depending on the desired depth, the number of cycles or focus of the laser may be adjusted. For this final procedure, CO₂ is utilized either intermittently or in tandem with the lasering. For intermittent CO₂, one or more laser passes are performed (step 6130) followed by one or more passes of CO₂ (step 6150). For tandem CO₂, the CO₂ spot, and the laser spot move with each other along the face or, in some implementations, a delay can be set within the CO₂ system to allow the CO₂ to lag behind or come before the next laser pulse.

In some implementations, the system is configured to apply a delay between laser passes to remove any condensation that may be present. In other implementations, a separate gas is applied (either through the CO₂ nozzle 1090 or through a separate nozzle) to remove condensation between laser passes. For example, the system may be configured to apply a sequence such as one laser cycle (step 6130), followed by one CO₂ cycle (step 6150), and then followed by one gas cycle (step 6170). This sequence is then repeated until the lasering is complete (step 6190). Delays and amounts of passes can all be altered/defined to achieve a desired result (e.g., machining depth, material to be machined, etc.). In some implementations, a chamber, which serves as a control volume, can also be applied with a gas cycle or to remove the need for a gas cycle. As noted above, a simple delay in time between laser passes can remove the need for a secondary gas, but this may increase the total processing time.

Once lasering is complete (step 6190), CO₂ is applied to the sample for a final cleaning (step 6210). A single pass of CO₂ over the sample surface or multiple passes may be used to further remove any debris from the cross-section. As noted above, the state of the CO₂ applied to the sample for the final cleaning (or for other steps in the machining process) may be adjusted or customized for a particular use depending on the desired outcome. For example, in some implementations, the final cleaning (step 6210) includes a first pass where CO₂ is applied in a gas form, a second pass where CO₂ is applied in the solid form (CO₂ snow), and a third pass where CO₂ is applied in the liquid form.

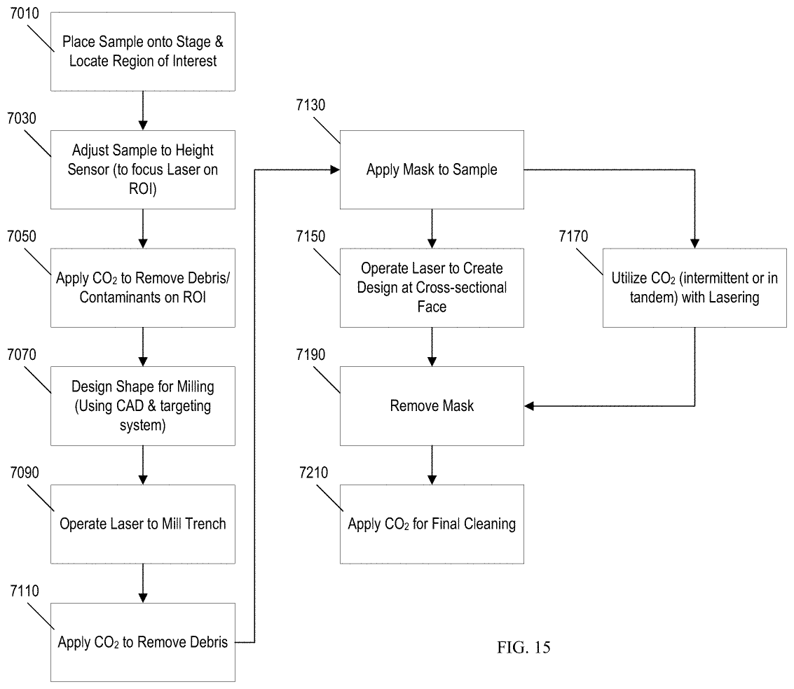

In the example of FIG. 14, the machining process is performed without the use of a mask. However, the machining system 1000 can also be operated using a physical mask to assist during the lasering. FIG. 15 illustrates an example of a machining process performed by the machining system 1000 using a mask. Again, the sample is placed on the sample stage 1010 and the region of interest is located (step 7010). The position of the sample is adjusted to focus the laser on the region of interest (step 7030) and CO₂ is applied to remove debris and/or contaminants from the region of interest (step 7050). The computer-assisted design system 3230 is used to design a shape for marking (step 7070) and then the laser is operated to mill a trench in the sample (step 7090) followed by an application of CO₂ to remove debris formed by the trench milling (step 7110).

After the trench is formed and debris is removed, the sample is covered with a mask (step 7130). In some implementations, it is important to achieve a tight seal with the mask for optimal results. It is not necessary to refocus the laser to account for the mask—although variations in focus can be made to affect the final cross-sectional area. Covering the sample with the mask prior to trench milling is also possible but may create more material build-up. After the mask is applied, the laser is operated to create the CAD-designed feature at the cross-sectional face (step 7150) while CO₂ is applied intermittently or in tandem with the laser (step 7170) as described above in reference to the example of FIG. 14. Once lasering is finishing, the mask is removed (step 7190) and CO₂ is applied to the sample for final cleaning (step 7210).

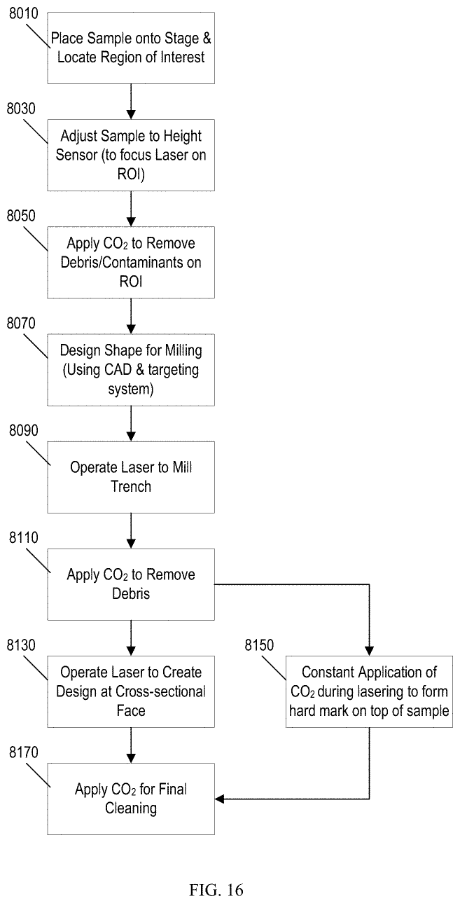

Although FIG. 15 describes an example in which a physical mask is coupled to the sample prior to the final lasering operation, in some implementations, the machining system 1000 may be configured to use the CO₂ system to generate a mask. FIG. 16 illustrates one such example. As in the previous examples, the sample is positioned on the sample stage 1010 and the region of interest is located (step 8010), the position of the sample is adjusted to focus the laser on the region of interest (step 8030), CO₂ is applied to remove debris/contaminants from the region of interest (step 8050), the CAD system 3230 is used to design a shape for machining (step 8070), the laser is operated to mill a trench (step 8090), and CO₂ is applied to remove debris generated by the trench milling (step 8110). However, for the final procedure, a constant application of CO₂ is utilized (step 8150) to form a visible hard mask on the top of the sample, which will act as a mask for lasering (step 8130). This can be achieved, for example, by (1) applying CO₂ next to the region of interest allowing the layer to form, but not directly interacting with the incoming laser pulses or (2) applying constant tandem CO₂ while lasering is being performed (step 8130). After lasering is finished the CO₂-generated mask is removed and CO₂ is again applied (step 8150) for final cleaning of the sample.

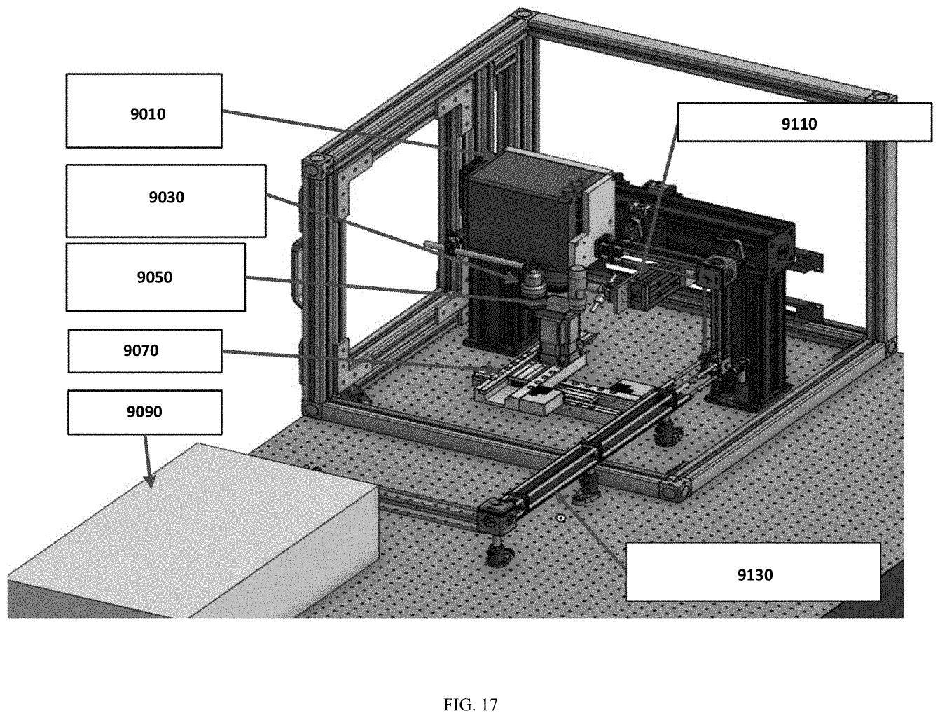

FIG. 17 is a perspective view of a CO₂-assisted laser machining system according to another implementation. FIG. 17 shows laser scan head 9010, confocal height sensor 9030, digital microscope 9050, XYZ stage 9070, laser head 9090, gas injection system 9110, and cage system beam path and beam expander 9130.

During a laser ablation process, some of the ablated material can be re-deposited onto the area that is being lasered. This often leads to sub-optimal laser ablation and poor surface quality due to creation/expansion of the heat affected zone (HAZ). The redeposited material can have various sizes ranging from low or sub micrometer to hundreds of micrometers, and therefore, a cleaning method that can remove both large and small particles are needed. In this implementation, the gas injection system (GIS) based on CO₂ snow cleaning method is used.

In various embodiments, a CO₂ snow cleaning method is a dry surface cleaning method in which a high-velocity stream of CO₂ gas and small dry ice particles (referred to as “snow”) are sprayed onto the surface. The snow is created by controlled expansion of gas or liquid CO₂ that is propelled through a small orifice right before the nozzle. Particle removal is primarily driven by two mechanisms.

In various embodiments, a first mechanism is the aerodynamic drag force provided by a high velocity CO₂ stream that exceeds the adhesion force between the particle and the surface. This mechanism is used to remove larger particles and is similar to how high-pressure air or nitrogen gas is used to assist material removal process. However, this mechanism struggles when it comes to small particle removal as the magnitude of the drag force decreases faster than the adhesion forces (e.g., van der Walls, capillary forces, and dipole attraction) with reduction in particle size.

In various embodiments, a second mechanism transfers the momentum from dry ice particles to small particles with diameters in low or even sub micrometer range and provides an improved method and system. In addition, as the CO₂ snow jet hits the surface, the temperature and pressure increase, which allows the CO₂ to reach the triple point where gas, liquid and solid CO₂ can exist simultaneously. In various embodiments, the capability of the CO₂ snow cleaning method allows the formation of a solid/liquid CO₂ mask on-demand at desired locations. Furthermore, liquid CO₂ acts as an excellent hydrocarbon solvent. This can clean the sample and prepare it for SEM and other high vacuum environments after the completion of the lasering process. In various embodiments, the incoming CO₂ has a temperature of −67° C. which also absorbs heat and aids in the elimination of HAZ during laser processing. In various embodiments, the laser cross-sectioning system has a secondary nozzle that supplies nitrogen gas, any buildup of condensation that the freezing temperatures of the GIS might introduce can be removed on-demand.

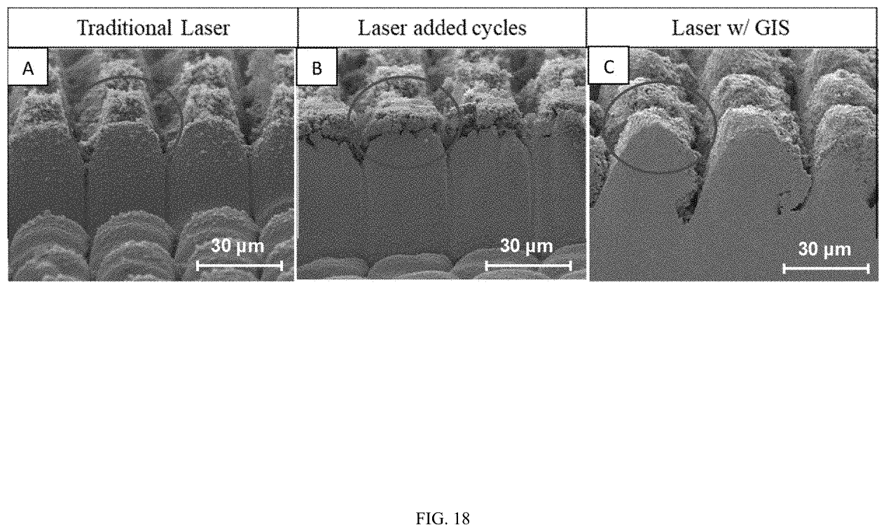

FIG. 18 shows cross-sections of samples cross-sectioned performed with different parameters. FIG. 18 (at A) shows a cross-section using a traditional laser. FIG. 18 (at B) shows a cross-section using laser added cycles. FIG. 18 (at C) shows a cross-section using a laser with gas injection system (GIS). Further, FIG. 18 shows cross-sections of a microelectronic device that were produced with (i.e., at C) and without the use of CO₂ (i.e., at A and B) processing, highlighting its effects on the redeposition control. FIG. 18 (at A) shows a cross-section performed with optimal laser parameters which displays a buildup of redeposition. FIG. 18 (at B) shows a cross-section performed with ten laser-cutting cycles to cut deeper which led to more redeposition and damage to structure. FIG. 18 (at C) shows cross-sections performed with the use of a GIS which improved the laser-cutting and eliminated the redeposition and improved the quality of the cross-sectional laser-cut.

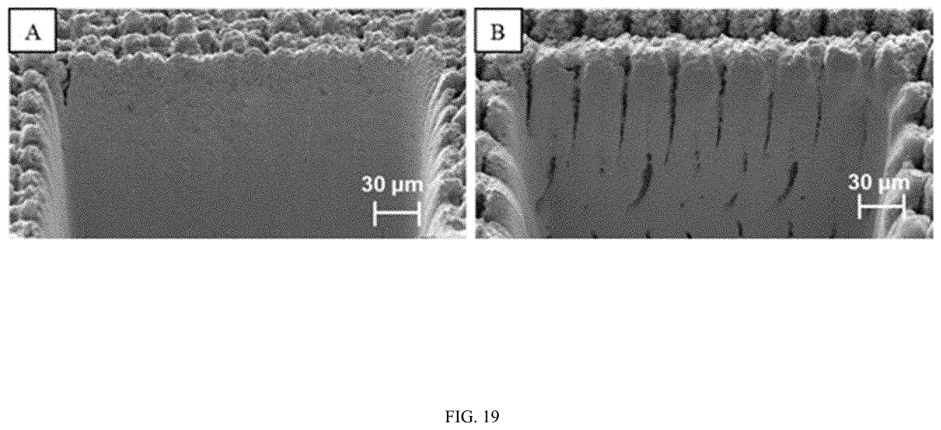

FIG. 19 shows cross-sections of samples cross-sectioned without CO₂ processing and cross-sectioned with CO₂ processing. FIG. 19 (at A) shows cross-sectioning performed without CO₂ processing which hides subsurface features due to formation of HAZ and melting of the microelectronic device and FIG. 19 (at B) shows cross-sectioning performed with CO₂ processing, displaying a wealth of subsurface information.

Without the use of CO₂ processing, a practical limit remains towards the amount of fluence (i.e., radiant energy received by the surface per unit area for each laser pulse) that can be applied to the sample during processing. Further, the limit about the amount of fluence exists where, at any time, an increase in fluence damages and melts the microelectronic device, thereby ruining the cross-sectional laser cut. In various embodiments, use of CO₂ removes the limit of fluence by eliminating the HAZ challenge. In various embodiments, the use of CO₂ processing allows for laser cross-sectioning methods and systems using fluences that are orders of magnitudes above what was previously considered to be a limit. In various embodiments, CO₂ processing provides for a significant decrease in processing time and results in a much higher quality cross-section using laser cross-sectioning methods and systems provided herein.

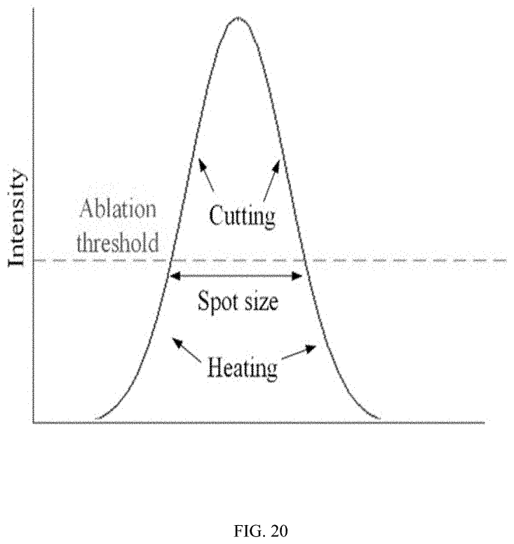

FIG. 20 shows a Gaussian beam profile of the intensity of the laser in relation to the ablation threshold. The typical minimum feature size of a laser system is limited by the laser beam focal spot size which at best is in the order of the beam's wavelength (λ), as dictated by the diffraction limit. The interaction volume of the beam can be larger than the spot size due, in part, to beam tails. Moreover, depending on the material that is interacting with the laser, a portion of the beam energy profile may fall below the ablation threshold and primarily be dissipated in the form of heat. These factors introduce challenges in terms of achieving a high-resolution, high-quality laser cross-section.

In various embodiments, the laser cross-sectioning methods and systems of the disclosure mitigate the challenges of the beam being larger than the spot size and the beam energy profile falling below the ablation threshold, thereby dissipating in the form of heat.

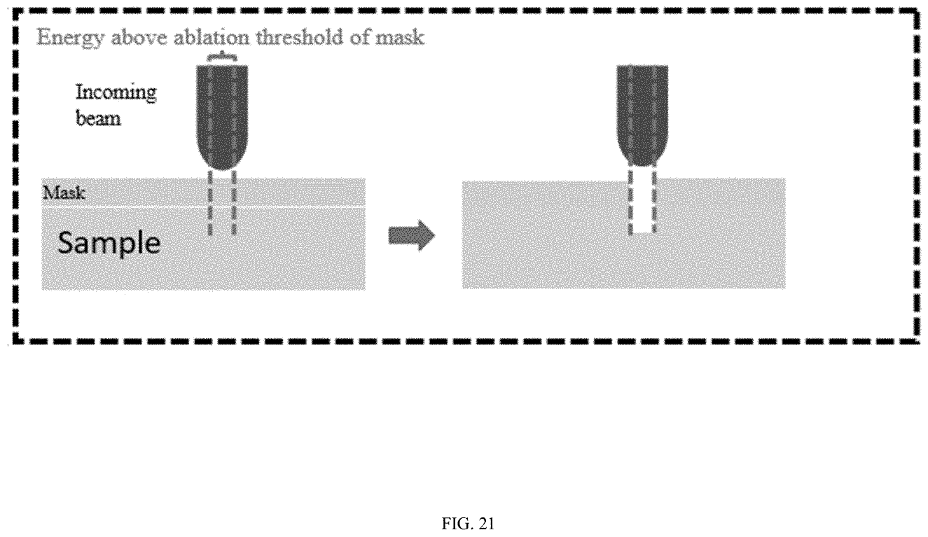

FIG. 21 shows a schematic depiction of an exemplary masking effect on laser beam tails. In various embodiments, the laser cross-sectioning methods and systems utilize a hard mask to overcome the challenge of the beam being larger than the spot size due, in part, to beam tails. In various embodiments, the physical hard mark is placed on top of the sample (i.e., microelectronic device). In various embodiments, the hard mark blocks and/or shades a threshold portion of the incident beam, effectively removing the beam tails from interacting and effecting the resulting cross-sections of the sample (i.e., microelectronic device).

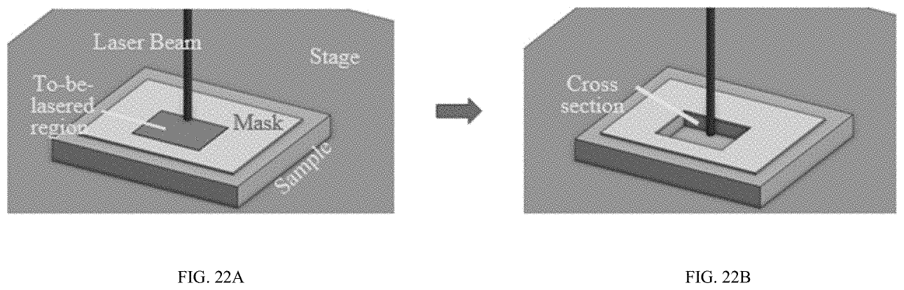

FIGS. 22A and 22B show a schematic sample orientation in relation to an incoming laser beam and a position of a hard mask. Consideration of how to affix the mask to the surface of the sample (i.e., microelectronic device) was contemplated. A hard mask was contemplated in the form of spin on glass, silver paint, or various stains that are self-adhering to the surface of the sample (i.e., microelectronic device). However, the contemplated hard mask would be non-removable and therefore, will always be present during imaging and, as such, would obscure features of the sample (i.e., microelectronic device).

In various embodiments, to overcome the challenges described above, a removable hard mark was contemplated. In various embodiments, the removable hard mark includes a piece of thin aluminum foil placed on top of the surface of the sample (i.e., microelectronic device). In various embodiments, the size of the piece of aluminum foil is selected such that the remaining areas of the vacuum stage are additionally covered. In various embodiments, the vacuum stage pulls the piece of aluminum foil downward creating a tight seal over the sample (i.e., microelectronic device). In various embodiments, during the lasering process the hard mask is penetrated by any incident beam with high enough fluence, the beam tails lack enough energy to reach the ablation threshold of the hard mask and therefore the top surface of the sample is protected from the beam tails. In various embodiments, the hard mask does not need to be replaced during the laser cross-sectioning process and can be easily removed post-laser cross-sectioning by removing the pull of the vacuum stage. In various embodiments, aluminum foil was selected as the material for the hard mask because it is readily available and inexpensive, and highly reflective of the incident laser beam. Additionally, the choice of the material of the hard mask does not need to be altered based upon any given laser type.

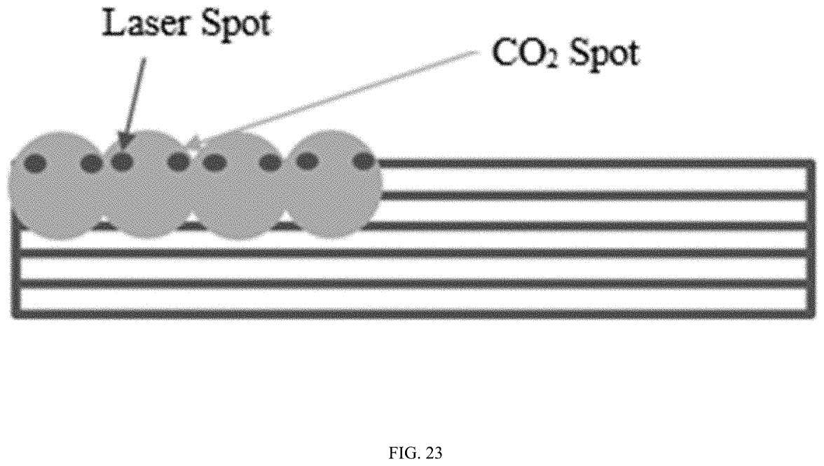

FIG. 23 shows a schematic depiction of a CO₂ system interacting with and shielding a sample in conjunction with a laser system. In various embodiments, it was contemplated to utilize the CO₂ injection mechanism for masking purposes. In various embodiments, the CO₂ stream is discharged prior to the lasering procedure from the laser system. In various embodiments, the CO₂ is delivered to the surface at freezing temperatures (i.e., −67° C.), which results in a thin layer of ice build-up on the surface of the sample (i.e., microelectronic device) covering the entire region of interest (ROI). In various embodiments, the thin layer of CO₂ remains on the surface of the sample as the lasering cycle begins. Upon completion of the laser process, the CO₂ injection system is turned off and the remaining ice mask can be blown away with compressed air.

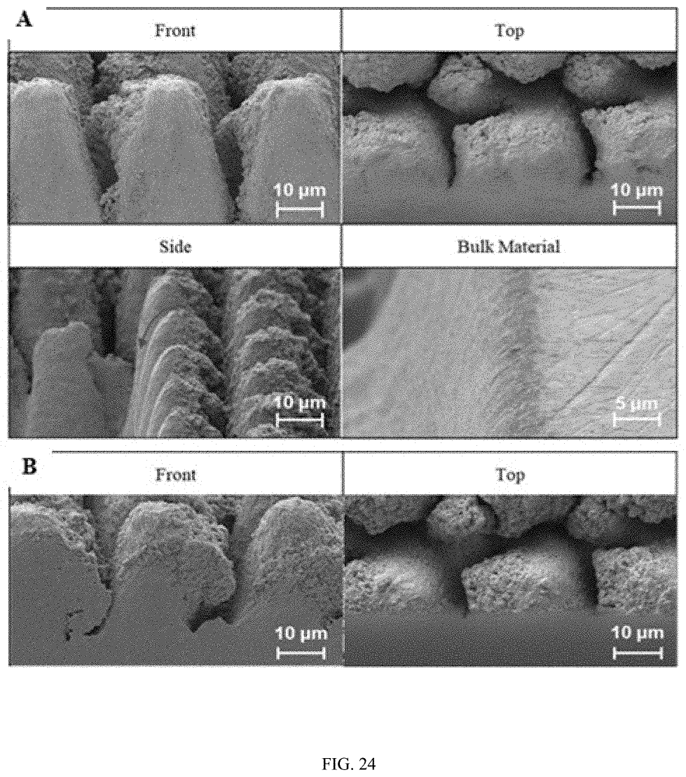

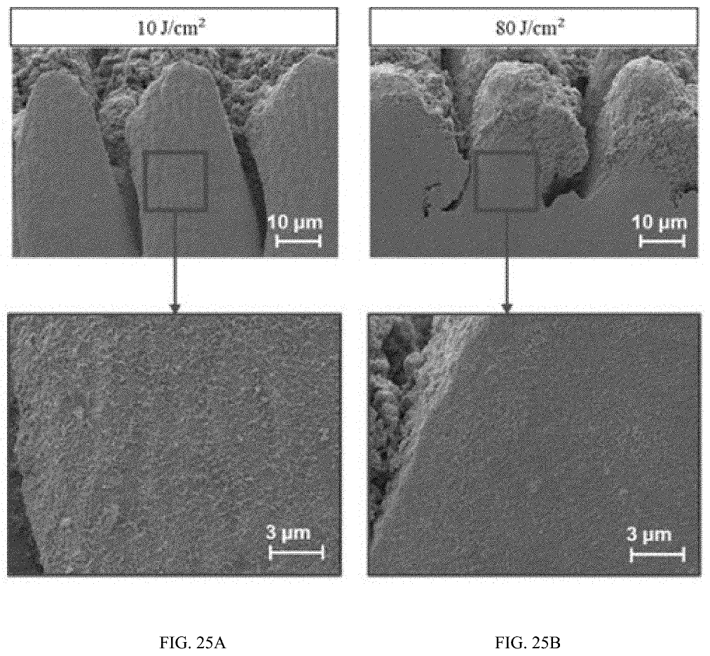

FIG. 24 shows an effect of laser beam tails on an experimental sample. FIG. 16 (at A) shows the effect of beam tails warping the surface features creating a sloped or curved profile on the top of the surface of the sample as indicated by the arrow in the “side” view. FIG. 16 (at B) shows the same structure after masking is applied and it was observed that no damage was caused to the top surface features of the sample. In various embodiments, it was observed that enabling the CO₂ injection system to track the laser and simultaneously create the same pattern as the laser resulted in a more effective mask of the damage caused by the laser beam.

### Experimental Data

The described cross-sectioning methods were applied to hierarchically restructured Platinum-Iridium (Pt/Ir) electrodes, that are used in neural interfacing applications. The surface geometry influences the electrochemical performance of electrodes, which is used to manufacture high performance electrodes. An acceptable process can include hierarchical surface restructuring (HSR™). In various embodiments, changes can be made to the subsurface structure that potentially affect the performance and, in some cases, might be detrimental to the integrity of the electrode. Therefore, the ability to rapidly obtain large-area cross-sections of samples, that have undergone the HSR™ process, is important to efficiently arrive at the optimized parameters for HSR™. The subsurface structural features of interest typically range from 0.5 μm to 5 μm. It is observed that a focused ion-beam (FIB) cross-section, spanning a length of only ˜150 μm and a few tens of microns, to capture some of such features takes a minimum of 10 hours. Such a process is prohibitively long when considering that one cross-section must be produced for each restructuring recipe and, as such, thousands of variations must be attempted to arrive at the optimal performance. In various embodiments laser cross-sectioning methods and systems provide a laser cross-section capable of revealing a region of such size in a matter of a few seconds.

Exemplary experiments were conducted to obtain the optimized lasering parameters for the laser cross-sectioning methods and systems. Table 5 provides the resulting optimized values for the parameters along the trends that were observed for each individual parameter. Furthermore, the parameters are ordered based on the impact or priority each has on the final outcome.

TABLE 5

| | | | Selected | |
|---|---|---|---|---|
| Priority | Parameter | Explanation | value | |
| 1 | Fluence | Increasing fluence resulted in a more polished cross- | 80 | J/cm² |
| | (J/cm²) | sectional face and faster material removal | | |
| 1a | Spot size | Smaller spot sizes performed better both in terms of | 8 | μm |
| | (μm) | milling rate and surface quality | | |
| 2 | X (spot) - | Higher overlaps produced better quality X-overlap | 86.36% | |
| | overlap (%) | values of <70% and >90% displayed an artifact so | | |
| | | called as laser induced periodic surface structures | | |
| | | (LIPSS) | | |
| 3 | Pattern | The optimal pattern both in terms of milling rate and | Contours | |
| | | quality was determined to be a contour pattern, starting | | |
| | | from the center, and proceeding to the outer boundary | | |
| | | of the defined shape. This pattern leads to an increase | | |
| | | in depth of cut and has the unique ability to reveal | | |
| | | multiple cross-sections with a single milling process | | |
| 4 | Pulsed laser | It appears that is X-overlap is kept constant, the | 10 | KHz |
| | repetition | outcome will not be sensitive to the repetition rate. | | |
| | rate | However, given the limitations in terms of practicing | | |
| | | certain combinations of parameters, repetition rate had | | |
| | | to be kept low, to allow for larger fluences. A lower | | |
| | | repetition rate was also desirable due to the laser | | |
| | | scanning limitations. | | |

| | | | |
|---|---|---|---|
| 4a | Y (line) - | Y-overlap shows minimal to zero effect on quality. | 50% |
| | overlap (%) | However, <50% Y-overlap results in a reduction in | |
| | | milling rate. | |
| 5 | No. of | Increasing the number of lasering cycles increases the | 50 |
| | lasering | cutting depth. | |
| | cycles | | |

In the order of Table 5 the first parameter is fluence, energy delivered per unit area, given by Equation 1:

$$Fluence \frac{( J )}{{cm}^{2}} = \frac{Epp}{2 {ω}_{0}} \qquad ( Eq . 1 )$$

Within Equation 1, the value “Epp” represents the energy per laser pulse given in Jules and the value “2ω₀” represents the effective laser spot size given in centimeters defined below in Equation 2:

$$2 {ω}_{0} = \frac{4 {M}^{2} λ f}{π D} \qquad ( Eq . 2 )$$

Where the value “ω₀” is the beam radius, the value “M” is the beam quality, the value “λ” is laser wavelength, and the value “f” is focal length, and the value “D” is diameter of the entrance beam of the f-theta objective. The spot overlap is defined as Equation 3:

$$\% Overlap = ( 1 - \frac{{v}_{s}}{2 {ω}_{0} {f}_{rep}} ) * 100 \qquad ( Eq . 3 )$$

Where the value “vₛ” is scanning velocity, the value “fᵣₑₚ” is the laser repetition rate or how many pulses are delivered to the sample per second. The laser pattern is how the laser spot is scanned across the surface by the galvanometer mirrors with the scan head. The number of cycles refers to how many times the selected pattern is repeated.

FIGS. 25A and 25B show a cross-section of “wet sand” artifact on the left, and another cross-section of “wet sand” on the right depicting a large mitigation of this artifact by increasing the fluence.

Throughout the exemplary experiments, an artifact in more than 70% of the exemplary experiments was observed. The artifact is denoted as “wet sand” and presents itself in a similar texture. It was observed that this can be mitigated with an increase in fluence in conjunction with an increase in the X-overlap of the laser pulses. In addition, with an increase in fluence there was a linear increase in material removal. Importantly, any concerns regarding the formation of heat affected zones (HAZs) and melting that could potentially be caused by high fluence values was eliminated with the use of the CO₂ gas injection system. As a result of such observations, fluence was determined to be of highest priority in the optimization and recipe building process. Further, due to the inverse relationship between spot size and fluence, it was determined that a smaller spot size was desirable. FIGS. 25A and 25B compares this wet sand artifact at two different fluences.

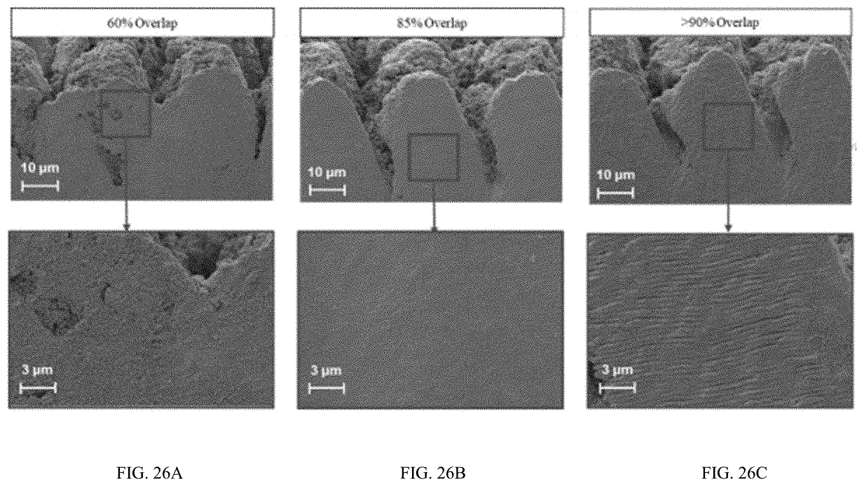

FIGS. 26A, 26B, and 26C show a cross-section of an experimental sample with a laser spot overlap of 60% overlap, 85% overlap, and 92% overlap. FIG. 26A shows a wet sand artifact with 60% overlap, FIG. 26B shows a polished face at 85% overlap, and FIG. 26C shows LIPSS artifact with 92% overlap.

A second common artifact known as laser induced periodic surface structures (LIPSS) was also apparent in many cross-sectioning trials. The parameters that were found to have the most dramatic effect on such phenomenon were X-overlap and the number of lasering cycles. Typically, high X-overlaps are not explored due to the damage they introduce on the surface. This is most often due to the confounding variable of HAZ. However, by leveraging the CO₂ gas injection system, the HAZ can be eliminated, enabling exploration of higher X-overlap values. It was observed that higher overlap values resulted in a reduction of the wet sand artifact. However, a LIPSS artifact emerged by increasing the X-overlap above 90%. Furthermore, an attempt to polish the face to mitigate such effect with hundreds of lasering cycles appeared to in fact worsen such effect. As a result, it was determined that the optimal outcome can be achieved by increasing the X-overlap up to the onset of the LIPSS formation. FIG. 18 compares cross-sectioning experiments, resulted from different X-overlap values.

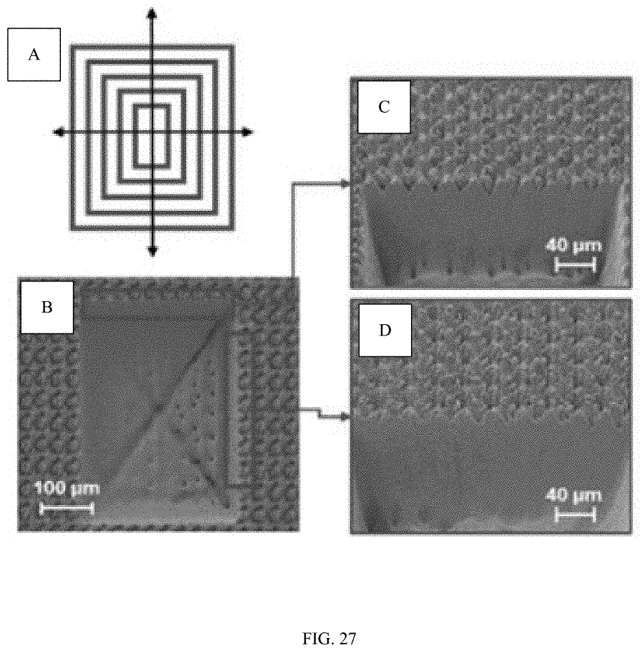

FIG. 27 shows an exemplary contour milling pattern.

Various lasering patterns were tested for creation of cross-sections. In various embodiments, the laser patterns included sorted lines, bidirectional lines, serpentine, and contour patterns. In various embodiments, it was determined that the optimal pattern both in terms of milling rate and quality was determined to be a contour pattern, starting from the center, and proceeding to the outer boundary of the defined shape, as can be seen in FIG. 27 (at A). This pattern leads to an increase in depth of cut and has the unique ability to reveal multiple cross-sections with a single milling process.

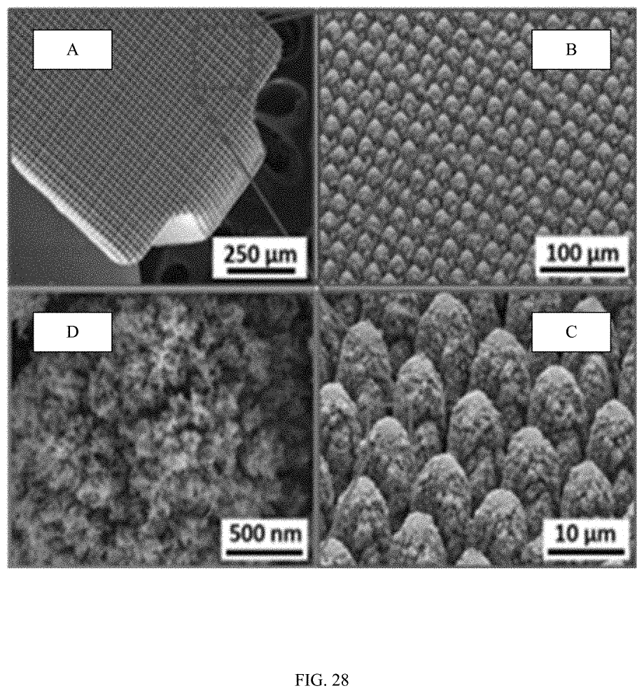

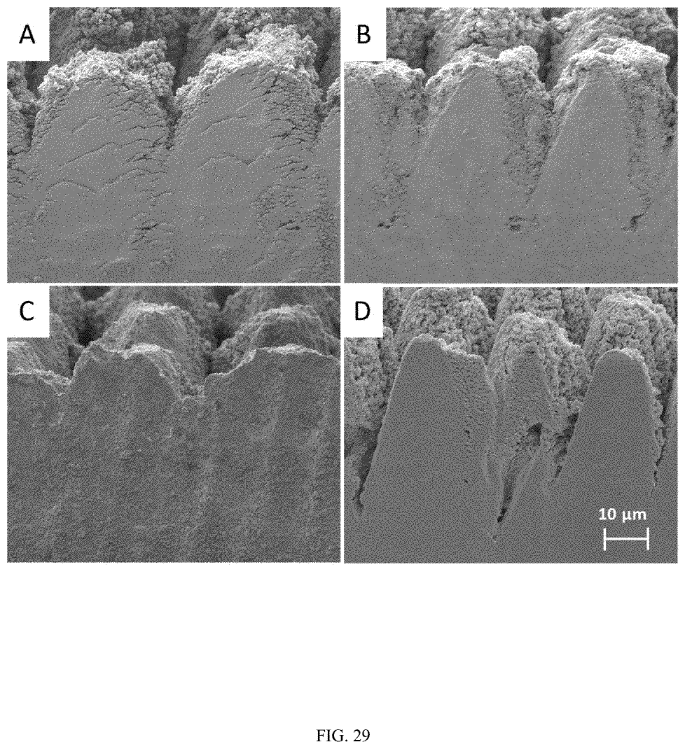

FIG. 28 shows SEM micrographs of the hierarchical surface structure of a Pt-10Ir electrode. FIG. 28 shows the hierarchical surfaces structure that was induced on the surface of a Pt-10Ir alloy electrode used for a paddle-lead spinal cord stimulation electrode array. FIG. 28 (at B) is a magnification of FIG. 20 (at A); FIG. 20 (at C) is a magnification of FIG. 20 (at B); and FIG. 20 (at D) is a magnification of FIG. 20 (at C).

A hierarchal restricted Pt/Ir electrode was used as the sample for conducting the cross-sections. The hierarchical surface structure induced on the surface as a result of restructuring can be observed in the SEM micrographs of the surface of the Pt/Ir electrode targeted for use in a paddle-lead spinal cord stimulation electrode array. The micrographs reveal that the surface hierarchy is notable by a periodic typography comprised of coarse-scale mound-like features that are about several microns wide and 10-15 μm high in size and a finer structure subset on top of the mound-like structures in the range of about a few nanometers to a few hundred nanometers in size. The optimized parameters, as described above, were applied for conducting various laser cross-sectioning. To mitigate the top surface damage, caused by the laser beam tails, CO₂ gas injection and aluminum foil were applied during the laser cross-sectioning as a masking strategy.

FIG. 29 shows secondary electron images of laser cross-sections of a control, CO₂ mask, aluminum foil mask, and CO₂ in conjunction with an aluminum foil mask. It was observed from the control experiment various tradeoffs of laser cross-sectioning are apparent, more specifically, material redeposition, melting, and top surface damage. It was observed from the CO₂ masking method results in the reduction of many of the tradeoffs observed from the control experiment. However, it was observed that when only foil was applied as a masking method the cross-sectional face degrades further. It was further observed that the hard mask traps the redeposition within the trench obscuring the cross-sectional face and increases the damage to the sample. Last, it was observed that when combining the CO₂ and aluminum foil masks an optimal cross-section is obtained with the elimination of the typical laser cross-sectioning shortcomings.

As a result from the exemplary experiments of FIG. 29, it was determined that the combination of hard and CO₂ masking would result in an optimal process capable of producing cross-sections that are comparable with focused ion-beams (FIB) in quality, yet with material removal rates that are 2,000,000× faster than Gallium focused ion-beams (FIB) and 40,000× faster than traditional lasering.

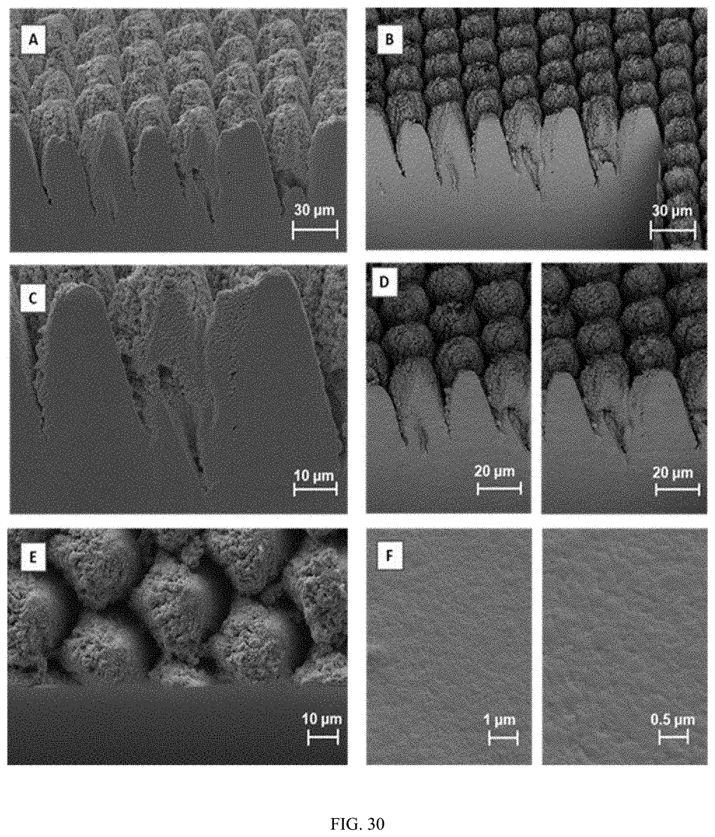

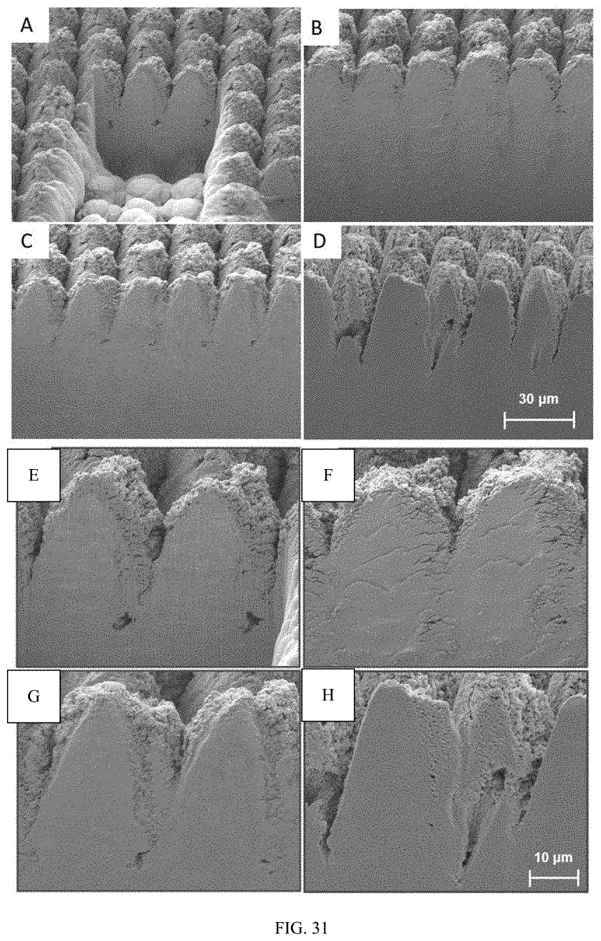

FIG. 30 shows results from an exemplary laser cross-sectioning process at various magnifications. FIG. 30 (at A) shows the cross-sectional face; FIG. 30 (at B) shows the backscattered electron at A, highlighting the planarity of the cross-sectional face; FIG. 30 (at C) shows the 2K× magnification at A; FIG. 30 (at D) shows the 1K× magnification at B; FIG. 30 (at E) shows the top-down view, highlighting the protection of top surface and the drop-off of the cross-sectional face; and FIG. 30 (at F) shows the 10KX and 20K× magnifications at B, highlighting the flatness.

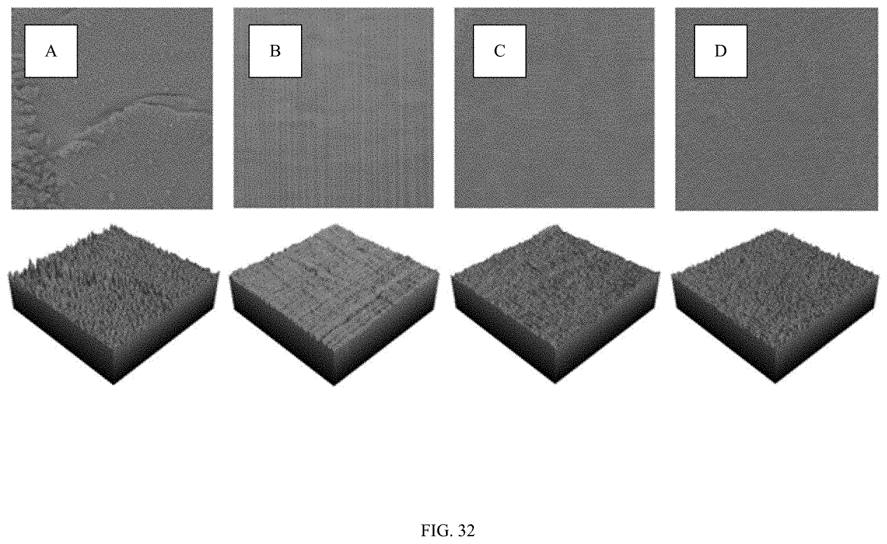

FIG. 31 shows comparative, cross-section SEM images showing results of using focused ion-beams, a control, CO₂ mask, and CO₂ in conjunction with an aluminum mask. FIG. 31 (at A) shows the focused ion-beam FIB; FIG. 31 (at B) shows the control; FIG. 31 (at C) shows the CO₂ mask; and FIG. 31 (at D) shows the CO₂ in conjunction with the aluminum mask. FIG. 31 (at E, F, G, and H) are magnified images of FIG. 31 (at A, B, C, and D, respectively).

To quantify the quality of different cross sections using laser and FIB, the surface roughness parameters Sa and Sq were compared. The arithmetic average surface roughness parameter Sa is the average of the absolute values of height deviations of the surface from the base plane. The base plane was selected as the horizontal plane at the average height of the surface, which typically is used and makes the bounded volume above and below this plane equal. The surface roughness parameter Sq is the root mean square of the height deviations from the base plane.

To estimate the height profile of the surface from the SEM images, we used a similar approach. The pixel brightness levels were considered as estimates of the heights, and Sa and Sq were calculated for the cross sections control, FIB, CO₂, and CO₂ with masking at 1500× magnification. The estimated values for Sa and Sq are presented in Table 6.

TABLE 6

| | | | | CO₂ in conjunction with aluminum |
|---|---|---|---|---|
| | Control | FIB | CO₂ | foil hard mask |
| Sa | 4.42 | 4.76 | 2.48 | 2.36 |
| Sq | 6.30 | 5.78 | 3.12 | 2.98 |

FIG. 32 shows various selected regions and their height estimates; from left to right, A is the control, B shows a focused-ion beam (FIB) method, C shows a CO₂ method, and D shows a CO₂ method in conjunction with an aluminum hard mask.

Table 7 compares the material removal rates of the proposed method with FIB and traditional lasering. The FIB cross-sectioning took a total 11 hours to reveal a 40 μm-wide face with a depth of 30 μm whereas the proposed laser method with the CO₂ gas injection system took 10 seconds to reveal a 250 μm-wide face with a 300 μm depth.

TABLE 7

| | | | Laser with CO₂ gas |
|---|---|---|---|
| Method | FIB | Traditional laser | injection system |
| Platinum ablation rate | 0.97 | 40 × 10³ | 1.56 × 10⁶ |
| [μm³/s] | | | |
| Time for ablation of | 1 year | 11 min | 17 s |
| 0.3 mm³ | | | |

Thus, the systems and methods described in the examples above provide, among other things, techniques for laser-based machining accompanied by the application of CO₂ to the surface being machined wherein the system is configured to synchronizing the movement of the CO₂ spot on the surface of the sample with the movement of the laser spot projected on the surface of the sample.

Other features and advantages are set forth in the accompanying claims.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

What is claimed is:

1. A material detection system comprising:
a laser system configured to controllably etch a specimen;
an imaging system configured to capture image data of an etched surface of the specimen; and
an electronic controller configured to
receive the image data from the imaging system, and
apply a machine learning model to determine a material composition of the specimen based at least in part on the image data.

2. The material detection system of claim 1, wherein the electronic controller is further configured to analyze the image data to quantify one or more surface texture parameters of the etched surface of the specimen, and wherein the electronic controller is configured to apply the machine learning model by applying a machine learning model configured to receive as input the one or more quantified surface texture parameters and to produce as output an indication of a material composition.

3. The material detection system of claim 2, wherein the electronic controller is further configured to operate the laser system by defining one or more laser parameters for the laser system, and wherein the electronic controller is configured to apply the machine learning model by applying a machine learning model configured to
receive as input the one or more quantified surface texture parameters and the one or more defined laser parameters, and
produce as output, in response to the received input, the indication of the material composition.

4. A method of operating the material detection system of claim 1 to train the machine learning model, the method comprising:
operating the material detection system to controllably etch a plurality of different samples and to capture image data of each etched sample, wherein the plurality of different samples include specimens of different material compositions,
generating a set of training data for each sample of the plurality of different samples, wherein each set of training data includes an indication of a material composition of the sample and one or more texture parameters for the sample based on the captured image data; and
training the machine learning model using the sets of training data, wherein the machine learning model is trained to produce as output an indication of a predicted material composition in response to receiving an input including one or more texture parameters for a sample of unknown material composition.

5. A laser-based milling system configured to mill a specimen including a plurality of layers, wherein adjacent layers of the specimen are formed of different material compositions, the laser based milling system comprising:
a femtosecond laser system configured to controllably etch the specimen;
an imaging system configured to capture image data of the etched surface of the specimen;
an electronic controller configured to
receive the image data from the imaging system,
apply a machine learning model to determine a material composition of the specimen based at least in part on the image data,
continue etching the specimen in response to determining, based on an output of the machine learning model, that the etched surface of the specimen is of a first material composition, and
stopping the etching of the specimen in response to determining, based on the output of the machine learning model, that the etched surface of the specimen is of a second material composition, wherein determining that the etched surface of the specimen is of the second material composition indicates that the laser system has etched through a first layer of the specimen and has exposed a second layer of the specimen, wherein the first layer of the specimen is formed of the first material composition and the second layer of the specimen is formed of the second material composition.

6. A laser-based machining system comprising:
a femtosecond laser source;
a laser-scanning system configured to direct a laser beam from the laser source to a surface of a sample and to controllably adjust a location of a laser spot where the laser beam contacts the surface of the sample;
a CO₂ nozzle configured to emit a CO₂ jet;
a CO₂ nozzle movement stage configured to controllably adjust a location of a CO₂ spot where the CO₂ jet contacts the surface of the sample by adjusting a position of the CO₂ nozzle relative to the sample;
an electronic controller configured to
control the laser scanning system to cause the laser spot to follow a defined machining path on the surface of the sample; and
control the CO₂ nozzle movement stage to cause the CO₂ spot to follow the defined machining path on the surface of the sample, wherein the movement of the CO₂ spot is synchronized with the movement of the laser spot.

7. The laser-based machining system of claim 6, wherein the electronic controller is further configured to machine the surface of the sample by controlling the laser scanning system to cause the laser spot to perform multiple passes along the defined machining path, wherein, between each pass of the multiple passes along the defined machining path, the electronic controller is configured to:
temporarily prevent the laser beam from contacting the surface of the sample,
operate the CO₂ nozzle to emit the CO₂ jet,
operate the CO₂ nozzle movement stage to cause the CO₂ spot to follow the defined machining path, and
operate the CO₂ nozzle to stop emitting the CO₂ jet after the CO₂ spot completes the defined machining path.

8. The laser-based machining system of claim 7, wherein, between each pass of the multiple passes of the laser spot along the defined machining path, the electronic controller is further configured to apply a gas spot to the surface of the sample along the defined machining path after causing the CO₂ nozzle to stop emitting the CO₂ jet.

9. The laser-based machining system of claim 6, wherein the electronic controller is configured to control the CO₂ nozzle movement stage by controlling the CO₂ nozzle movement stage to cause the CO₂ spot to follow the laser spot along the defined machining path by a defined delay period.

10. The laser-based machining system of claim 6, wherein the electronic controller is configured to control the CO₂ nozzle movement stage by controlling the CO₂ nozzle movement stage to cause the CO₂ spot to precede the laser spot along the defined machining path by a defined delay period.

11. The laser-based machining system of claim 6, further comprising a CO₂ system configured to selectively cause the CO₂ nozzle to emit a gaseous form, a liquid form, and a solid form.

12. The laser-based machining system of claim 6, wherein the hard mask comprises aluminum foil.

13. The laser-based machining system of claim 6, wherein the laser spot comprises an 85% overlap.

14. The laser-based machining system of claim 6, wherein the laser spot comprises a size of 8 μm.

15. A method of inspecting an interior structure of a microelectronic integrated circuit package using the laser-based machining system of claim 6, the method comprising:
operating the laser-scanning system to machine a trench in a surface of the microelectronic integrated circuit package while applying the synchronized CO₂ spot to the surface of the microelectronic integrated circuit package.
